(19) United States
(12) Patent Application Publication
(10) Pub. No.: US 2026/0098763 A1
(43) Pub. Date: Apr. 9, 2026

(54) ACTIVATABLE THERMAL INDICATORS WITH THERMALLY EXPANSIVE MATERIALS

(71) Applicant: Temptime Corporation, Morris Plains, NJ (US)

(72) Inventors: Brian S. HUFFMAN, Belle Mead, NJ (US); Eric W. LIBERATO, Pequannock, NJ (US); Mohannad ABDO, Clifton, NJ (US)

(73) Assignee: Temptime Corporation, Morris Plains, NJ (US)

(21) Appl. No.: 18/906,961

(22) Filed: Oct. 4, 2024

(51) Int. Cl. G01K 11/04; G01K 7/16; G01K 7/34; G01K 11/12

(52) U.S. Cl. CPC G01K 11/04; G01K 7/16; G01K 7/34; G01K 11/12

(57) ABSTRACT

Activatable thermal indicators with thermally expansive materials are disclosed herein. An example is provided by an activatable indicator including a plurality of microcapsules, each of the plurality of microcapsules further including a frangible shell, a volatile material contained in the frangible shell, configured to transition to a gas when heated above a predetermined activation temperature, wherein responsive to a first activation action including an application of heat configured heat above the predetermined activation temperature, the volatile material causes the frangible shell to weaken or rupture, and a payload contained in the frangible shell, the payload containing a liquefiable material configured to liquefy responsive to a predetermined environmental exposure, the payload configured to be released from the frangible shell when the frangible shell is ruptured.

### BACKGROUND

Environmental indicators may be configured to indicate the occurrence of an environmental exposure to a host product. Prior to the association between the host product and the indicator, the same level of care must often be paid to the indicator to prevent an exposure to the environmental condition which the indicator is configured to indicate, so that the indicator is not triggered prematurely and rendered unusable for use with the host product. For example, high temperature exposure indicators may need to be kept in deep freeze or refrigerated conditions, complicating the component supply chains for the products they are used with. Activatable environmental indicators have been previously proposed.

### SUMMARY

In an embodiment, the technology of the present disclosure is provided by an activatable indicator including a plurality of microcapsules, each of the plurality of microcapsules further including a frangible shell, a volatile material contained in the frangible shell, configured to transition to a gas when heated above a predetermined activation temperature, wherein the frangible shell is configured to rupture responsive to a first activation action, the first activation action including an application of heat configured causing the volatile material to transition to a gas and expand in volume causing the frangible shell to weaken or rupture, and a payload contained in the frangible shell, the payload containing a liquefiable material configured to liquefy responsive to a predetermined environmental exposure, the payload configured to be released from the frangible shell when the frangible shell is ruptured. Prior to the first activation action, the frangible shell is configured to contain the payload when the liquefiable material is liquefied and when the liquefiable material is not liquefied.

In a variation of this embodiment, the frangible shell is configured to rupture responsive to the volatile material expanding in volume by at least a predetermined amount.

In a variation of this embodiment, the volatile material is contained in an expandable microsphere encapsulated within the frangible shell.

In a variation of this embodiment, the frangible shells are configured to weaken responsive to the volatile material expanding in volume by at least a predetermined amount and configured to be ruptured responsive to a second activation action once weakened, the second activation action including an application of a compressive stress or a shear stress above a predetermined stress threshold.

In a variation of this embodiment, the first activation action is an exposure to a temperature above the predetermined activation temperature for at least an activation threshold duration.

In a variation of this embodiment, the predetermined environmental exposure is an exposure to a temperature above an indication threshold temperature for at least an indication threshold duration.

In a variation of this embodiment, the indication threshold temperature is less than the predetermined activation temperature, and the indication threshold duration is greater than the activation threshold duration.

In a variation of this embodiment, the predetermined activation temperature is in a range bounded by 50 degrees Celsius (C) and 350 degrees C.

In a variation of this embodiment, the activation threshold duration is in a range bounded by 1 millisecond and 5 seconds.

In a variation of this embodiment, each of the plurality of microcapsules has a diameter length in a range of 20 micrometers (μm) to 1000 μm.

In a variation of this embodiment, the frangible shell includes a material selected from a group consisting of a protein, a gel, a polyurea formaldehyde, a polymelamine formaldehyde, a wax material, an emulsion, and combinations thereof.

In a variation of this embodiment, the predetermined environmental exposure is selected from a group consisting of: a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

In a variation of this embodiment, the liquefiable material is selected from a group consisting of a polymer having side-chain crystallinity, polymeric materials, an alkane, a wax, an alkane wax, esters, and combinations thereof.

In a variation of this embodiment, the first activation action is a heat exposure applied by a thermal printhead.

In a variation of this embodiment, the second activation action is a compressive stress applied by a thermal printhead.

In a variation of this embodiment, the predetermined stress threshold is selected from a group consisting of: a stress exceeding 0.1 psi a stress exceeding 0.5 psi, a stress exceeding 1 psi, a stress exceeding 2 psi, a stress exceeding 5 psi, a stress exceeding 10 psi, and a stress exceeding 15 psi.

In a variation of this embodiment, the payload further includes an indicator material, configured to produce an observable change in the activatable environmental exposure indicator after the liquefiable material is liquefied, the observable change selected from a group consisting of a change of reflectivity, a change in transparency, a change in hue, a change in chroma, a change in apparent color, a change in conductivity, a change in resistance, a change in impedance, a change in capacitance, and combinations thereof.

In a variation of this embodiment, the payload further includes an indicator material selected from a group consisting of dyes, leuco dyes, a color forming agent, a color developing agent, chemical pigments, particles containing copper, particles containing silver, particles containing graphite, particles containing conductive metals, particles containing conductive non-metal materials, and combinations thereof.

In a variation of this embodiment, the observable change is irreversible.

In a variation of this embodiment, the volatile material contained in each microcapsule has a volume that is between 1% and 20% of a volume of each microcapsule before the volatile material expands.

In a variation of this embodiment, the volatile material expands by between 10% and 1000% in response to the first activation action.

In an embodiment, the technology of the present disclosure is provided by an activatable indicator, including a substrate, a wick, an indicator region, a plurality of microcapsules, each microcapsule further including: a frangible shell, a volatile material contained in the frangible shell, configured to transition to a gas responsive to being heated above a predetermined activation temperature, wherein responsive to a first activation action including an application of heat configured heat the volatile material to a temperature above the predetermined activation temperature, the volatile material transitions to a gas and expands in volume causing the frangible shell to weaken or rupture, and a payload contained in the frangible shell, the payload containing a liquefiable material configured to liquefy responsive to being exposed to a temperature above a predetermined indication temperature. The payload is configured to be released from the frangible shell when the frangible shell is ruptured. Prior to the first activation action, the frangible shell is configured to contain the payload when the liquefiable material is liquefied and when the liquefiable material is not liquefied. When the payload is released from the frangible shell and the liquefiable material is liquefied responsive to an exposure to the temperature above the predetermined indication temperature, the payload is configured to migrate along the wick. When the exposure to the temperature above the predetermined indication temperature ceases, the liquefiable material solidifies and the payload halts migration along the wick, and when the exposure to the temperature above the predetermined indication temperature resumes, the liquefiable material liquefies, and the payload resumes migration along the wick. The payload is configured to reach the indicator region responsive to the liquefiable material having been liquefied for a predetermined cumulative period of time. The payload is configured to produce an observable effect in the indicator region when the payload reaches the indicator region.

In a variation of this embodiment, the frangible shell is configured to rupture responsive to the volatile material expanding in volume.

In a variation of this embodiment, the volatile material is contained in a microsphere encapsulated within the frangible shell.

In a variation of this embodiment, the frangible shells are configured to be ruptured responsive to a second activation action once weakened, the second activation action including an application of a compressive stress or a shear stress above a predetermined stress threshold.

In a variation of this embodiment, the plurality of microcapsules is coupled to the activatable indicator by a bonding material in which the plurality of microcapsules is contained or embedded.

In a variation of this embodiment, the wick is configured such that the payload migrates along the wick at a predetermined rate when the liquefiable material is liquified, and the payload reaches the indicator region after a predetermined period of time and produces the observable effect.

In a variation of this embodiment, the payload includes an indicator material contained or embedded in a matrix of the liquefiable material when the liquefiable material is solidified, such that when the liquefiable material is liquefied, the indicator material is released from the matrix.

In a variation of this embodiment, the liquefiable material, when liquefied, is configured to facilitate migration of the indicator material to the indicator region.

In a variation of this embodiment, the indicator material includes two mutually reactive substances which are held separately in the matrix and react with one another when the liquefiable material is liquefied, such that a reaction between the two mutually reactive substances produces the observable effect.

In a variation of this embodiment, the payload includes a first substance which is held in the matrix, and the indicator region includes a second substance reactive with the first substance, and the first substance and the second substance react with one another when the first substance is released from the matrix and migrates to the indicator region when the liquefiable material is liquefied, such that a reaction between the first substance and the second substance produces the observable effect.

In a variation of this embodiment, the liquefiable material is selected from a group consisting of a polymer having side-chain crystallinity, polymeric materials, an alkane, a wax, an alkane wax, esters, and combinations thereof.

In a variation of this embodiment, the indicator material is selected from a group consisting of a colorant, a color forming agent, a color developing agent, a dye, a leuco dyes, a chemical pigment, particles containing copper, particles containing silver, particles containing graphite, particles containing conductive metals, particles containing conductive non-metal materials, and combinations thereof.

In a variation of this embodiment, the observable effect is a change in an apparent color state of the indicator region selected from a group consisting of a change of reflectivity, a change in transparency, a change in hue, a change in chroma, a change in apparent color, and combinations thereof.

In a variation of this embodiment, the observable effect is a change in an electrical property of the indicator region selected from a group consisting of a change in conductivity, a change in resistance, a change in impedance, a change in capacitance, and combinations thereof.

In a variation of this embodiment, the first activation action is an exposure to a temperature above the predetermined activation temperature for at least an activation threshold duration.

In a variation of this embodiment, the predetermined activation temperature is greater than the predetermined indication temperature, and the activation threshold duration is less than the predetermined cumulative period of time.

In a variation of this embodiment, the predetermined activation temperature is defined within a range bounded by 50 degrees Celsius (C) and 350 degrees C.

In a variation of this embodiment, the activation threshold duration is defined within a range bounded by 1 millisecond and 5 seconds.

In a variation of this embodiment, the predetermined indication temperature is defined within a range bounded by −15 degrees Celsius (C) and 35 degrees C.

In a variation of this embodiment, the predetermined cumulative period of time is greater than 1 second.

In a variation of this embodiment, the first activation action is applied by a thermal printhead.

In a variation of this embodiment, each of the plurality of microcapsules have diameter lengths in a range of 20 micrometers (μm) to 1000 μm.

In a variation of this embodiment, the frangible shell includes a material selected from a group consisting of a protein, a gel, a polyurea formaldehyde, a polymelamine formaldehyde, a wax material, an emulsion, and combinations thereof.

In a variation of this embodiment, the plurality of microcapsules is coupled to the substrate by a laminating layer securing the plurality of microcapsules therebetween.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIGS. 1A-1D illustrate various stages of first embodiment of an activatable microcapsule, according to embodiments of the present disclosure.

FIGS. 2A-2D illustrate various stages of a second embodiment of an activatable microcapsule, according to embodiments of the present disclosure.

FIGS. 3A-3E illustrate various stages of a general embodiment of an activatable environmental exposure indicator employing activatable microcapsules, according to embodiments of the present disclosure.

FIG. 4 illustrates a single excursion variant of an activatable environmental exposure indicator, according to embodiments of the present disclosure.

FIG. 5 illustrates a progressive variant of an activatable environmental exposure indicator, according to embodiments of the present disclosure.

FIG. 6 illustrates an electrically sensitive variant of an activatable environmental exposure indicator, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

The technology of the present disclosure is related to an activation platform for environmental indicators, such as thermal and time-temperature indicators. Environmental indicators (e.g., indicators incorporating an indicator material that liquifies in response to a predetermined environmental exposure) may be configured to indicate the occurrence of such a predetermined environmental exposure to a host product, e.g., by changing appearance or by changing an electrical property of the indicator which may be detected by an appropriate circuit or computer. Prior to the association between the host product and the indicator, the same level of care must be paid to the indicator to prevent an exposure to the environmental condition of which the indicator is configured to indicate, such that the indicator is not spent prematurely and rendered unusable with the host product. Said differently, if a thermal indicator is to be installed on a host product, the indicator may need to be held below the temperature at which the thermal indicator is configured to indicate prior to installation of the indicator on or with a monitored host product. If a sufficient thermal exposure were to occur prior to pairing with the host product, the indicator would transition to an indicative state prior to installation, and, provided the indicator is an irreversible indicator, the indicator would be expended prior to use. For example, indicators configured for use with refrigerated items, e.g., indicators showing when host products have warmed above a refrigerator temperature, the indicators generally need to be refrigerated prior to being paired with a host product, which results in an additional cost and more complicated inventory management and manufacturing process for the user. Using an indicator that requires an application of an activation action before becoming sensitive to environmental exposure may help avoid these problems.

Indicators may employ microcapsules containing a payload. The microcapsule are rupturable by application of an activation action, such as an external application of a compressive or shear force, and/or the application of heat sufficient to melt, weaken, or rupture the frangible shells of the microcapsules to facilitate release of the payload. The microcapsules of the present disclosure contain a thermally expansive material, which is configured to expand, generally responsive to heating, inside of the microcapsule, increasing in volume such that sufficient forces are generated to rupture, or substantially weaken, the frangible shell of the microcapsule from the inside.

In some embodiments of the present disclosure, the microcapsules include both a payload and one or more thermally expansive microspheres, the thermally expansive microspheres having an expandable shell containing a thermally expansive material. The expandable shell of the thermally expansive microspheres can isolate the thermally expansive material from the payload. The payload and thermally expansive microsphere are contained in the same frangible shell of the indicator microcapsules. Subjecting the indicator microcapsules to an activation action, the thermally expansive material expands, causing an expansion of the expandable shell of the thermally expansive microspheres, and in turn causing the expansion of the frangible shell, inducing a strain on the frangible shell, which can be driven to the point of rupture by the expanding thermally expansive microsphere, thus releasing the payload from the indicator microcapsule. The thermally expansive microsphere can remain intact in response to the activation action such that the thermally expansive material remains isolated from the payload.

In other embodiments, the payload is contained along with a thermally expansive material inside the frangible shell without isolating the thermally expansive material in the expandable shell of the thermally expansive microsphere. Upon being subjected to an activation action, the thermally expansive material expands, directly inducing a strain on the frangible shell, which can be driven to the point of rupture, thus releasing the payload from the microcapsule.

In some examples, the frangible shell is not driven to the point of rupture by the thermally expansive microsphere, (or the thermally expansive material, respectively) but is instead driven to a predetermined state of weakness, such that a secondary activation action, such as the application of a sheer or other force, may be taken to release the payload from the microcapsule.

The discussion contained in the following detailed description has been organized as follows:

### Section I: Some Relevant Materials and Notable Properties Thereof.

### Section II: Embodiments of Rupturable Microcapsules

### Section III: Embodiments of Activatable Environmental Exposure Indicators.

### Section I: Some Relevant Materials and Notable Properties Thereof

### Liquefiable Materials

Various embodiments of activatable environmental exposure indicators discussed herein utilize a liquefiable material that can be configured to react to an environmental exposure temperature above a predetermined threshold relatively quickly. This is because the liquefiable material of some embodiments is configured or selected to have a sharp melting point, such that liquefaction happens very quickly over a small temperature range. Thus, exposure to a predetermined environmental exposure, e.g., a peak temperature exceeding the melting point of the liquefiable material, causes a quick state change. However, notwithstanding a relatively quick response by the liquefiable material to heat, some indicators discussed herein exhibit a time-dependent response that halts when conditions return below the environmental exposure temperature threshold and resumes again in an additive manner. Again, in some embodiments, this is due to the liquefiable material having a sharp transition between a liquid phase and a solid phase.

In other words, where an indicator is configured to signal a response after an exposure of about 30 minutes at and/or above the environmental exposure temperature threshold, a 20-minute exposure will not trigger a response, but if the indicator is again exposed to a temperature at and/or above the environmental exposure temperature threshold, only about ten more minutes of exposure will yield a response. In some embodiments as noted above, this behavior is achieved because the liquefiable solid (such as a side-chain crystalline polymer) readily solidifies within a narrow temperature range. Once the environmental exposure temperature has been exceeded, a drop in temperature below the environmental exposure will cause almost immediate cessation of the time-dependent response. The response will resume once the environmental exposure temperature threshold is again exceeded.

As used herein, the terms “predetermined environmental exposure” and “environmental exposure temperature threshold” have an understood meaning in the art and include a temperature, usually a temperature above 0° C. (though temperatures below 0° C. are also contemplated), that can cause damage or harm to a product, such as a food or a vaccine that may require refrigeration to avoid spoilage or maintain efficacy for extended periods. The term “environmental exposure temperature threshold,” then, can include any predetermined temperature that is above a desired storage temperature of a perishable product, though in some cases exposure for short periods of time may not damage or harm a particular product. Thus, some embodiments disclosed herein can be configured to provide signal of exposure to temperatures at and/or above an environmental exposure temperature threshold only after a specified amount of time even if exposure occurs at different times.

In some embodiments, the liquefiable material has a “sharp” liquefaction point, meaning that the transition from solid to liquid happens very quickly over a very small temperature range. In some embodiments, liquefaction temperature and solidification temperature of the liquefiable solid are identical. In some embodiments, the liquefaction and solidification temperatures are within about 0.1° C., within about 0.5° C., within about 1.0° C., within about 1.5° C., within about 2° C., within about 2.5° C., within about 3.0° C., within about 3.5° C., within about 4.0° C., within about 4.5° C., within about 5° C., or within about 10° C. of each other.

As used herein, the term “solid phase” may refer to a material in a non-liquid state such that the material is incapable of fluid flow. In some examples “solid phase” may refer to a gelled state, a highly viscous state, a true solid state, and the like. Similarly, the terms “solidification” and “solidify” are used to describe the transition in which a material not in the solid phase enters the solid phase. The terms “solidification point” and “solidification temperature” are used to describe a temperature, or temperature range, at or in which a material may undergo solidification.

As used herein, the term “liquid phase” is used to describe a state of a material in which the material is capable of fluid flow. Similarly, the terms “liquefaction” and “liquefy” are used to describe the transition in which a material not in the liquid phase enters the liquid phase. The terms “liquefaction point” and “liquefaction temperature” are used to describe a temperature, or temperature range, at or in which a material may undergo liquefaction.

Suitable liquefiable materials include synthetic polymeric materials that are solid below the threshold temperature and are, or can become, a flowing amorphous solid or a viscous liquid when at and/or above a threshold temperature. Such synthetic polymeric materials are liquefiable. Useful synthetic polymers can also be hydrophobic, if desired. Suitable liquefiable materials include side-chain crystallizable polymers (e.g., various methacrylates, such as poly(hexadecylmethacrylate); a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms).

As used herein, the term “polymer”, and its linguistic variations, refers to copolymers, and higher order polymers, as well as homopolymers, unless the context indicates otherwise, for example, by describing or referencing one or more specific homopolymers.

When solid, the synthetic polymeric material can be crystalline or partially crystalline. Crystalline or partially crystalline synthetic polymeric materials can have desirably sharp transitions from a solid state to a liquid state.

Side chain (liquid) crystalline polymers (abbreviated as SCC hereafter) are particularly suitable liquefiable materials, though other suitable materials such as waxes could readily be used. SCC polymers have a conventional polymer backbone and side chains that can co crystallize. Typically, they are chains that have six or more carbons with a crystallization temperature that is, therefore, adjustable. In some embodiments, the side chains “melt” independently of the main polymer chain so that the phenomenon can be used to release other materials that have been encapsulated within the overall polymer structure. Another advantage of SCC polymers is that their molecular weight and degree of crosslinking can be adjusted to control their physical properties including their permeability and in turn provide an approach to tailor the time delay.

Some examples of SCC polymers include poly(dodecylacrylate), poly(tetradecylacrylate), poly(hexadecylacrylate), poly(octadecylacrylate), copolymer of hexylacrylate and dodecylacrylate, copolymer of hexylacrylate and docosylacrylate, copolymer of decylacrylate and tetradecylacrylate, copolymer of decylacrylate and octadecylacrylate, copolymer of decylacrylate and octadecylacrylate, copolymer of decylacrylate and octadecylacrylate, copolymer of dodecylacrylate and docosylacrylate, copolymer of dodecylacrylate and docosylacrylate, copolymer of dodecylacrylate and docosylacrylate, copolymer oftetradecylacrylate and octadecylacrylate, copolymer oftetradecylacrylate octadecylacrylate, copolymer oftetradecylacrylate and octadecylacrylate, poly(dodecylmethacrylate), poly(tetradecylmethacrylate), poly(hexadecylmethacrylate), poly(octadecylmethacrylate), copolymer of tetradecylmethacrylate and methyl methacrylate, copolymer of octadecylmethacrylate and methyl methacrylate.

For example, the liquefiable material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8:117-253 (1974), the disclosure of which is hereby incorporated by reference. In general, these polymers contain monomer units X of the formula:

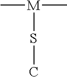

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide-will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for example ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common examples are: linear aliphatic side chains of at least 10 carbon atoms, e.g., C₄-C₂₂ acrylates or methacrylates, acrylamides or methacrylamides, vinyl ethers or esters, siloxanes or alpha olefins; fluorinated aliphatic side-chains of at least 6 carbons; and p-alkyl styrene side-chains wherein the alkyl is of 8 to 24 carbon atoms.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific examples of side-chain crystallizable monomers are the acrylate, fluoroacrylate, methacrylate and vinyl ester polymers described in J. Poly. Sci 10:3347 (1972); J. Poly. Sci 10:1657 (1972); J. Poly. Sci 9:3367 (1971); J. Poly. Sci 9:3349 (1971); J. Poly. Sci. 9:1835 (1971); J.A.C.S. 76:6280 (1954); J. Poly, Sci 7:3053 (1969); Polymer J. 17:991 (1985), corresponding acryl amides, substituted acrylamide and maleimide polymers (J. Poly. Sci: Poly. Physics Ed. 18:2197 (1980)); polyalphaolefin polymers such as those described in J. Poly. 5,156,911 7 Sci. Macromol. Rey, 8:117-253 (1974) and Macromolecules 13:12 (1980), polyalkylvinylethers, polyalkylethylene oxides such as those described in Macromolecules 13:15 (1980), alkylphosphazene polymers, polyamino acids such as those described in Poly. Sci. USSR 21:241, Macromolecules 18:2141, polyisocyanates such as those described in Macromolecules 12:94 (1979), polyurethanes made by reacting amine- or alcohol-containing monomers with long-chain alkyl isocyanates, polyesters and polyethers, polysiloxanes and polysilanes such as those described in Macromolecules 19:611 (1986), and p-alkylstyrene polymers such as those described in J.A.C.S. 75:3326 (1953) and J. Poly. Sci 60:19 (1962). Of specific utility are polymers which are both relatively polar and capable of crystallization, but wherein the crystallizing portion is not affected by moisture. For example, incorporation of polyoxyethylene, polyoxy propylene, polyoxybutylene or copolyoxyalkylene units in the polymer will make the polymer more polar.

In a particularly preferred embodiment herein, in the above structure, —C is selected from the group consisting of —(CH₂)—CH₃ and —(CF₂)ₙ—CF₂H, where n is an integer in the range of 8 to 20 inclusive, —S— is selected from the group consisting of —O—, —CH₂—, —(CO)—, —O(CO)— and —NR— where R is hydrogen or lower alkyl (1-6° C.), and -M- is —[(CH₂)ₘ—CH]— where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hydrophilic monomers as detailed in WO84/0387, cited supra.

Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N. Y., Sartomer USA, LLC, Exton Pa., and Polysciences, Inc. Other materials may be SCCs alone, without SCCs, or alkane waxes blended without SCCs.

### Microcapsules

Various embodiments of activatable environmental exposure indicators and activation indicator components discussed herein utilize microcapsules having frangible shells, which are employed to microencapsulate several other materials (e.g., liquefiable materials, indicator materials, thermally expansive materials, thermally expandable microspheres) forming a microcapsule. The frangible shells are rupturable, e.g., the frangible shells rupture and release the payload when subjected to an activation action.

The microcapsules may be any size, but in one such embodiment, has an outer diameter length between 20-1000 μm. The frangible shell may be any size smaller than or equal to the outer diameter of the microcapsule. The microcapsules can have a thickness between 5 to 25 micrometers (μm). The payload ratio, or the ratio of the total weight of the payload within the microcapsule to the entire weight of the microcapsule including the contents contained within the microcapsule, can range from 50 percent to 90 percent. A variety of microcapsule frangible shell materials may be chosen, depending on the application, the mode of rupture, and the nature of the contents of the microcapsule. In general, the microcapsules should resist the passage, whether by flow, diffusion, or migration, of the contents of the microcapsule prior to rupturing.

For example, the frangible shell may be formed in whole or in part by a wax, e.g., an alkane wax, or other acid resistant compound having a relatively high melting point, e.g., fatty acid amide, an ester or Elvax EVA resin. For example, the melting point may be in a range of about 50 degrees Celsius (C) to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. Generally, the shell should have a higher melting point than the maximum temperature the microcapsule is expected to be exposed to in normal use, to prevent it from rupturing or melting prematurely.

In another example, the frangible shell may be formed in whole or in part by a polymer coating having a high glass transition temperature (T_{g}) e.g. Polysulfone. For example, the glass transition temperature may be in a range of about 50 degrees C. to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. For example, Polysulfone, with a T_{g} of about 190 C may be used. In additional examples, the microcapsules 100 may be one of Styrene Maleic Anhydride (SMA), Polyphenylene Ether (PPE), Cellulose Acetate, Cellulose Diacetate, Polyacrylate, Polyamide, Polycarbonate, polyether ether ketone, Polyether Sulfone, PET, PFA, polymethyl methacrylate (PMMA) or Polyimide.

In another example, the frangible shell may be formed in whole or in part by a low molecular weight polymer gel having a high melting point, e.g., fatty acid amide, an ester or Elvax EVA resin. For example, the melting point may be in a range of about 100 degrees C. to about 300 degrees C., from about 150 degrees C. to about 300 degrees C., from about 200 degrees C. to about 300 degrees C., from about 250 degrees C. to about 300 degrees C. Additionally, in some examples, the polymer gel has a molecular weight in a range from about 1 grams per mole (g/mol) to 100,000 g/mol, from about 3,500 g/mol to 6,000 g/mol and from about 200 g/mol to 2,000 g/mol.

Alternatively, the frangible shell may be formed in whole or in part by a gel, gelatin, protein, polyurea formaldehyde, polymelamine formaldehyde, wax material, melamine, or an emulsion. The microcapsules may be available in wet and dry formulations. Polymelamine and polyurea formaldehyde can both be used for encapsulations via interfacial polymerization, which uses two immiscible phases. Once separated in the same vessel, a reaction is initiated at the interface of the two immiscible phases in the presence of an initiator and the material to be encapsulated. As polymerization occurs, microcapsules form around the core material. The microcapsule releases the contents of the microcapsule upon rupturing.

The microcapsule is initially in an unruptured form, capable of being configured to transition to a ruptured form through exposure to an activation action, e.g., the application of heat, pressure, and/or a combination of heat and pressure exceeding a predetermined threshold. In the unruptured form, the frangible shell of the microcapsule maintains separation between the contents of the microcapsule and any external environmental stimuli and/or contains a phase change of the contents of the microcapsule in response to any external environmental stimuli.

The frangible shells may be “ruptured” (e.g., broken, disengaged, dissolved, etc.) by applying an activation action to the microcapsule. In some examples “applying an activation action” may constitute exposing the microcapsule to an activation action, such as a pressure stress or a thermal stress, or a combination thereof. The activation action may directly or indirectly cause the frangible shell to fracture, melt, break, dissolve, sublime, become porous, or otherwise disengage, allowing the release of the contents of the frangible shell. In some examples, the frangible shells may be ruptured by one or more activation actions. In some such examples, simultaneous activation actions may be applied to rupture the microcapsules. In other such examples, sequential activation actions may be applied to rupture the microcapsules.

The frangible shells may have one or more of various rupture modes (e.g., or weaking modes), to which the activation action or actions correspond. Each activation action may be configured to have a predetermined activation threshold at which the microcapsule is configured to rupture. In some examples, each activation action may be configured to have a predetermined activation threshold at which the frangible shell of the microcapsule is weakened (e.g., but not ruptured) to a predetermined extent, such that the predetermined activation threshold of a second activation action necessary to rupture the microcapsule is lowered (when compared to the predetermined activation threshold of the second activation alone). Said differently, a first activation action may lower an energy requirement of a second activation action in order to activate the microcapsule.

A first rupture mode is rupture or weakening by means of internally applied pressure. In some such examples, the microcapsules may be ruptured or weakened by a source of internal pressure, where the activation action is configured to trigger expansion of a material within the frangible shell (e.g., a thermally expansive material, thermally expandable microsphere) which increases the internal pressure of the microcapsule, which ruptures or weakens the frangible shell.

In some such examples, the predetermined activation threshold corresponds to a radial stress or a hoop stress (e.g., acting on the frangible shell) of sufficient magnitude to rupture the frangible shell. In some examples, the predetermined activation stress threshold is a radial stress or hoop stress exceeding about 0.1 pounds per square inch (psi), a radial stress or hoop stress exceeding about 0.5 psi, a radial stress exceeding about 1 psi, a radial stress exceeding about 2 psi, a radial stress or hoop stress exceeding about 5 psi, a radial stress or hoop stress exceeding about 10 psi, or a radial stress or hoop stress exceeding about 15 psi. The activation stress ranges given are purely exemplary and the microcapsules can be formed to respond to other stress ranges.

A second rupture mode is rupture or weaking by means of heat exposure. In some examples, the microcapsules may be ruptured or weakened by a source of heat, where the activation action is an exposure to a temperature configured to melt, degrade, decrease the structural integrity of, or otherwise disengage the frangible shell. In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C., a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

In some such examples, activation may be achieved by applying a high temperature for a very short interval, e.g., a few milliseconds. For example, the mass or heat of fusion of the indicator may be much greater than the mass or heat of fusion of a barrier that needs to be removed, allowing a short exposure to high temperature to remove or alter the microcapsule without significantly affecting an thermally sensitive indicator material contained in the microcapsule.

A third rupture mode in rupture or weaking by means of externally applied pressure. In some examples, the microcapsules may be ruptured by a source of external pressure, where the activation action is an exposure to a compressive or shearing force. The frangible shells may be configured such that the predetermined activation threshold corresponds to a compression stress or a shear stress of sufficient magnitude to rupture the frangible shell. In some examples, the predetermined stress threshold is a compressive stress or a shearing stress exceeding about 0.1 pounds per square inch (psi), a compressive stress or a shearing stress exceeding about 0.5 psi, a compressive stress or a shearing stress exceeding about 1 psi, a compressive stress or a shearing stress exceeding about 2 psi, a compressive stress or a shearing stress exceeding about 5 psi, a compressive stress or a shearing stress exceeding about 10 psi, or a compressive stress or a shearing stress exceeding about 15 psi. The activation stress ranges given are purely exemplary and the microcapsules can be formed to respond to other stress ranges.

In some examples in which two activation actions are required to rupture the microcapsules, the activation actions may employ the same rupture modes, enacted at different thresholds, or different rupture modes.

In some examples, one activation action may trigger multiple rupture modes. As a non-limiting example, a microcapsule may be configured such that the first activation action in an exposure to a temperature above the predetermined activation threshold. The exposure to the temperature above the predetermined activation threshold may trigger a thermally expansive material contained in the microcapsule to expand, providing an internal pressure source, and the exposure may also cause weaking of the frangible shell. In this manner, two rupture modes are enacted on the microcapsule via a single activation action.

In some examples, the activation action(s) may be applied by a thermal printhead (e.g., of a thermal printer). Thermal printheads are generally configured to provide a source of heat (e.g., via heating elements) and a source of external pressure (e.g., via a nib formed between a platen roller and the printhead). Typical thermal print heads have temperatures in the range from about 100° C. to 300° C., which may be tuned downward for select applications to from about 100° C. to 200° C. They are typically exposed to thermal print heads for a brief period of time, for example a few milliseconds. Furthermore, the platen roller may be configured, adjusted, or tuned, such that the external pressure applied by the thermal printhead (e.g., and the platen roller) is in the range of 0.1 psi to 15 psi. As a non-limiting example, the microcapsules may be configured such that the heat from the thermal printhead triggers a thermally expansive material contained in the microcapsule to expand, providing an internal pressure source, which weakens the frangible shell, and the external compressive force of the nib provides sufficient stress to rupture the frangible shell, rupturing the microcapsules.

The activation pressure and temperature ranges given are purely exemplary and other ranges may be sufficient to rupture or weaken the frangible shells, where such pressure ranges may vary based on a composition of the frangible shell, a thickness of the frangible shell, a ratio between the shell thickness or weight to volume or weight of the indicator material, a diameter of the microcapsules, a temperature applied to the shells, etc.

According to some embodiments, the frangible shell is electrically nonconductive, insulative, resistive, or otherwise resists, and may substantially prevent the conduction of electricity through the microcapsule.

### Volatile Materials

Various embodiments of activatable environmental exposure indicators and activation indicator components discussed herein utilize volatile materials, or thermally expandable microspheres containing volatile materials. In order to distinguish between the many materials which are naturally volatile or thermally expansive, and the volatile materials suitable for use in the disclosed applications, suitable volatile materials are thermally expansive materials which increase in volume by at least 50% over a temperature range of at most 10 degrees Celsius. More specifically, suitable volatile materials are either liquid (or substantially liquefied) and solid (or substantially solidified) materials the which rapidly transition to a gas (or substantially gaseous phase) responsive to heating over a small temperature range, such that heating to a predetermined activation temperature results in a rapid transition of the volatile material to a gas. Generally speaking, thermally expansive materials produce a gas through physical changes, such as volatilization or expansion responsive to an increase in temperature. Various volatile materials have vaporization points (or sublimation points) across a wide range of temperatures. The volatile materials selected for use in the disclosed technology are selected according to the intended environments in which they are to be employed, thus volatile materials with excessively high vaporization points (or sublimation points) (e.g., above 350 degrees C.) may be unsuitable for use with the disclosed technology. Furthermore, suitable volatile materials are noncorrosive with respect to the frangible shells, liquefiable materials, and expandable shells in which the volatile material may be contained. Suitable volatile materials are generally safe for human exposure in a consumer setting, and therefore not noxious, not corrosive and not radiative. Many chemicals suitable for use as volatile materials are used as blowing agents or foaming agents.

Some examples of volatile materials include certain hydrocarbons (e.g., pentane, butane), which are volatile liquids that vaporize upon heating, resulting in the production of a gas. Some example hydrocarbons suitable for use as volatile materials include: propane, (iso)butane, (iso)pentane, (iso)hexane, (iso)heptane, (iso)octane, (iso)nonane, (hydrocarbons having 3 to 13 carbon atoms, such as (iso)decane, (iso)undecane, (iso)dodecane, and (iso)tridecane; hydrocarbons having more than 13 to 20 carbon atoms, such as (iso)hexadecane and (iso)cicosane; hydrocarbons such as petroleum fractions such as pseudocumene, petroleum ether, normal paraffins and isoparaffins having a first distillation point of 150 to 260° C. and/or a distillation range of 70 to 360° C.; halides of hydrocarbons having 1 to 12 carbon atoms, such as methyl chloride, methylene chloride, chloroform, and carbon tetrachloride; fluorine-containing compounds such as hydrofluoroether; silanes having an alkyl group having 1 to 5 carbon atoms, such as tetramethylsilane, trimethylethylsilane, trimethylisopropylsilane, and trimethyl-n-propylsilane; and compounds which generate gas by thermal decomposition by heating, such as azodicarbonamide, N,N′-dinitrosopentamethylenetetramine, and 4,4′-oxybis(benzenesulfonylhydrazide). These volatile materials may use 1 type or 2 or more types together. The volatile material may be linear, branched or alicyclic, or aliphatic.

Some examples of hydrocarbons suitable for use as volatile materials include hydrocarbons with 1 to 18 carbon atoms. The hydrocarbons can be saturated or unsaturated hydrocarbons. The hydrocarbons can be aliphatic, cyclic or aromatic hydrocarbons; preferred hydrocarbons are ethane, propane, butane, n-butane, iso-butane, n-pentane, iso-pentane, neo-pentane cyclo-pentane, hexane, iso-hexane, n-hexane, cyclohexane, heptane, iso-heptane, octane, iso-octane, decane, dodecane, iso-dodecane and hexadecane. Volatile materials can be selected from chlorinated or fluorinated hydrocarbons mentioned above; preferred chlorinated or fluorinated hydrocarbons are methyl chloride, methylene chloride, dichloroethane, trichloroethane, trichlorofluoromethane and perfluorinated hydrocarbons. Furthermore, volatile materials can be selected from tetra-alkyl silanes such as tetramethyl silane, tri-methylethyl silane, tri-methylisopropyl silane and trimethyl n-propyl silane. Volatile materials can be selected from ethers including chlorinated or fluorinated ethers.

In some embodiments of the present disclosure, volatile materials are included in thermally expandable microspheres. Thermally expandable microspheres may include a thermoplastic shell encapsulating a thermally expansive material. The thermoplastic shell is usually a polymer formed of one or more monomers, such as nitrile-based monomers, carboxyl group-containing monomers, (meth)acrylic acid ester-based monomers, styrene-based monomers, vinyl ester-based monomers, acrylamide-based monomers, and halogenated vinylidene-based monomers. More specifically, the thermoplastic shell may be formed in whole or in part by nitrile type monomers, such as acrylonitrile, methacrylonitrile, fumaronitrile; carboxyl group-containing monomers such as acrylic acid, methacrylic acid, ethacrylic acid, crotonic acid, cinnamic acid, maleic acid, itaconic acid, fumaric acid, citraconic acid, and chloromaleic acid; halogenated vinyl monomers such as vinyl chloride; halogenated vinylidene-based monomers such as vinylidene chloride; vinyl ester-based monomers such as vinyl acetate, vinyl propionate, and vinyl butyrate; Methyl (meth) acrylate, ethyl (meth) acrylate, n-butyl (meth) acrylate, t-butyl (meth) acrylate, 2-ethylhexyl (meth) acrylate, stearyl (meth) acrylate, (meth) acrylic acid ester-based monomers such as phenyl (meth) acrylate, isobornyl (meth) acrylate, cyclohexyl (meth) acrylate, benzyl (meth) acrylate, and 2-hydroxyethyl (meth) acrylate; (meth) acrylamide-based monomers such as acrylamide, substituted acrylamide, methacrylamide, and substituted methacrylamide; maleimide-based monomers such as N-phenylmaleimide and N-cyclohexylmaleimide; styrene-based monomers such as styrene and α-methylstyrene; ethylenically unsaturated monoolefin monomers such as ethylene, propylene and isobutyrene; vinyl ether-based monomers such as vinyl methyl ether, vinyl ethyl ether, and vinyl isobutyl ether; vinyl ketone-based monomers such as vinyl methyl ketone; N-vinyl-based monomers such as N-vinylcarbazole and N-vinylpyrrolidone; A vinyl naphthaline salt etc. are mentioned. The monomer component may use these radically polymerizable monomers 1 type or 2 or more types together. In addition, (meth)acryl means acryl or methacryl.

When heated, the thermoplastic shell softens and simultaneously the thermally expansive material volatilizes while being retained within the thermoplastic shell, causing an expansion of the thermally expandable thermoplastic microspheres to form expanded microspheres. Thermally expandable thermoplastic microspheres may be provided in a wet form (e.g. an aqueous slurry or a wet cake) or as a dry powder.

Thermally expandable thermoplastic microspheres are known in the art, as disclosed in, for example, U.S. Pat. No. 3,615,972.

Examples of thermally expandable microspheres which may be suitable for use in the disclosed applications include Expancel® products produced by Nouryon of Amsterdam, Netherlands, such as Expancel 031 DU 40, Expancel 044 DU 20, Expancel 044 DU 40, Expancel 051 DU 40, Expancel 053 DU 40, Expancel 093 DU 120, Expancel 909 DU 80, Expancel 920 DU 120, Expancel 920 DU 20, Expancel 920 DU 40, Expancel 930 DU 120, Expancel 950 DU 80, Expancel 951 DU 120, and Expancel 980 DU 100; KUREHA Microspheres produced by the Kureha Corporation of Tokyo, Japan, such as Kureha H750 Microspheres, Kureha H850 Microspheres, Kureha H880 Microspheres, Kureha S2340 Microspheres, Kureha S2640 Microspheres, and Kureha H 1100-S Microspheres; and AdvanCell® products produced by the Sekisui Chemical Co. of Tokyo, Japan, including AdvanCell EML101 Microspheres, AdvanCell EM H204 Microspheres, AdvanCell EHM302 Microspheres, AdvanCell EHM303 Microspheres, AdvanCell EM 306 Microspheres, AdvanCell EM308 Microspheres, AdvanCell EM 403 Microspheres, AdvanCell EM406 Microspheres, AdvanCell EM501 Microspheres, AdvanCell EM504 Microspheres, and AdvanCell EM505 Microspheres.

### Indicator Materials

According to some embodiments, the microcapsules disclosed herein contain a payload including a liquifiable material and an indicator material. When in the solid state, the liquefiable material may substantially prevent movement, migration or diffusion of the indicator material through the liquefiable material. When the liquefiable material is in the liquid state, the indicator material may be able to migrate, move or diffuse through the liquifiable material, and in some examples the indicator material is transportable by the liquefiable material.

Generally, an indicator material produces or facilitates the production of a detectable indication, e.g., a change in color state or electrical property, in response to a predetermined environmental stimulus, e.g., heating above a threshold temperature. When combined with a liquefiable material, the indicator material is configured to produce, either alone or in combination with other elements, a detectable indication when the liquefiable material liquefies (e.g., in response to a predetermined environmental exposure).

Some embodiments of indicator materials discussed here utilize two or more compounds capable of reacting with each other to yield a color change. In some examples, the two or more reactants may be separated within a single microcapsule and prevented from mutual contact by a liquefiable material in a solid state. In some embodiments two or more reactants may be and contained in distinct microcapsules, which substantially prevent the compounds from interacting prior to the rupturing of the microcapsules. Alternatively, a first of the compounds may be contained in the microcapsules, and a second of the compounds may be disposed in the indicator region of the indicator.

Used in combination with the liquifiable material, in some embodiments, are color-reacting materials, such as two reactants kept separate by the microcapsules but allowed to react with each other after rupture or migration. Dyes can also be dissolved in such liquifiable materials to provide an intense color. In some embodiments, the color-reacting materials, or color-forming reactants, produce a distinct color change or change in opacity when brought into contact with each other.

When the reactants come into contact, the appearance change of the indicator may be to go from clear to black, from clear to a dark color, from a light color to a dark color, from a light color to black, etc. In some embodiments, a background is visible through the liquifiable layer(s) prior to the reaction, thereby indicating that the predetermined temperature threshold and required exposure period have not yet been satisfied. The background may include words, numbers, or a pattern, or may simply comprise a color that is easily obscured by the color-forming reaction of the reactants. In some embodiments, a pattern on the background is at least partially obscured by the light color of the liquifiable layer(s), and the pattern becomes more visible after the color-forming reaction. For example, if the pattern is formed with an ink having a color similar to the color of the pre-reacted reactants, a color change produced by the interaction of the color-forming reactants may render the pattern more visible.

Some embodiments discussed herein utilize conductive particles which, when employed in tandem with a liquefiable material, may be held separately from one another when the liquefiable material is in the solid phase, and be configured to form an electrical connection between two electrodes when the liquefiable material is in the liquid phase. Thus, by measuring the conductivity between the two electrodes, the state of the liquefiable material can be determined, or rather, an exposure of the liquefiable material to the predetermined environmental exposure may be confirmed. According to some embodiments, the conductive particles may include particles of conductive metals, such as copper, silver, gold, aluminum, zinc, tin, similar metals, and alloys thereof. The conductive particles may also include particles of graphene, graphite, carbon black, graphene oxides, and other functionalized graphenes, and particles containing conductive non-metals. The conductive particles may be formed in whole or in part by any electrically conductive substance or material operable to be partialized to a sufficient size to fit within the shell of a microcapsule.

Some embodiments of indicator materials discussed herein utilize colored or bright materials, such as dyes, flash materials, and other colorants. In some examples, liquefaction of the liquefiable material may result in a change in opacity of the liquefiable material, which may reveal or obscure the indicator material. In some examples, the liquifiable material may transport the indicator material from a non-viewable or concealed location to a viewable location when in the liquid state.

### Section II: Embodiments of Activatable Microcapsules

### Activatable Microcapsule: First Embodiment

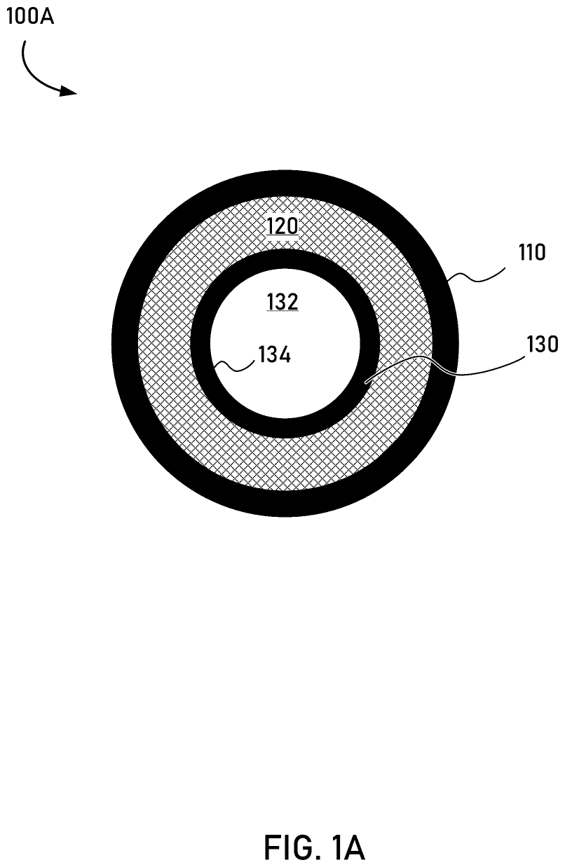

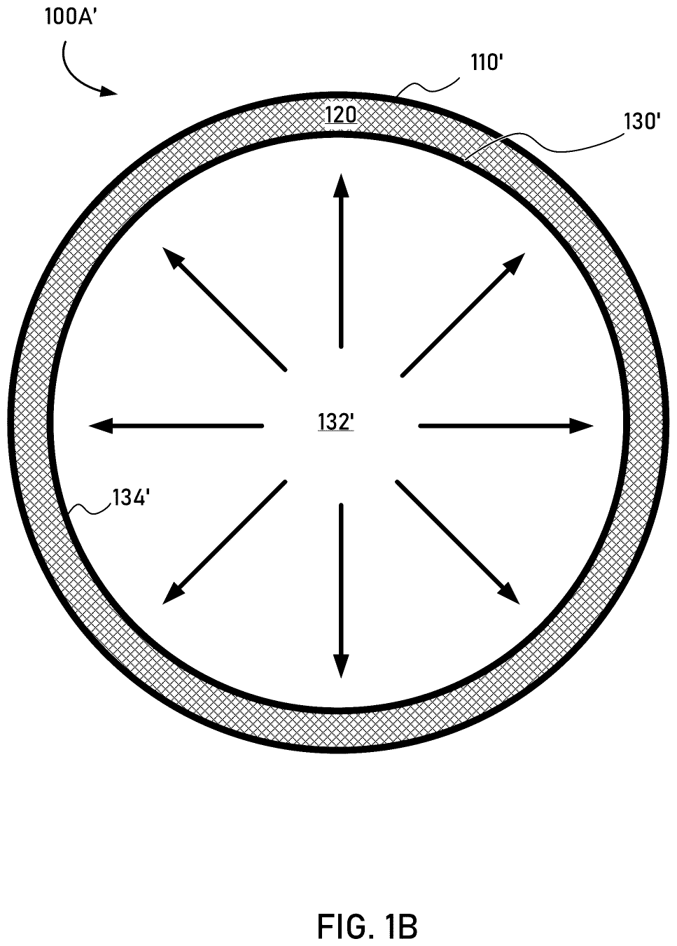

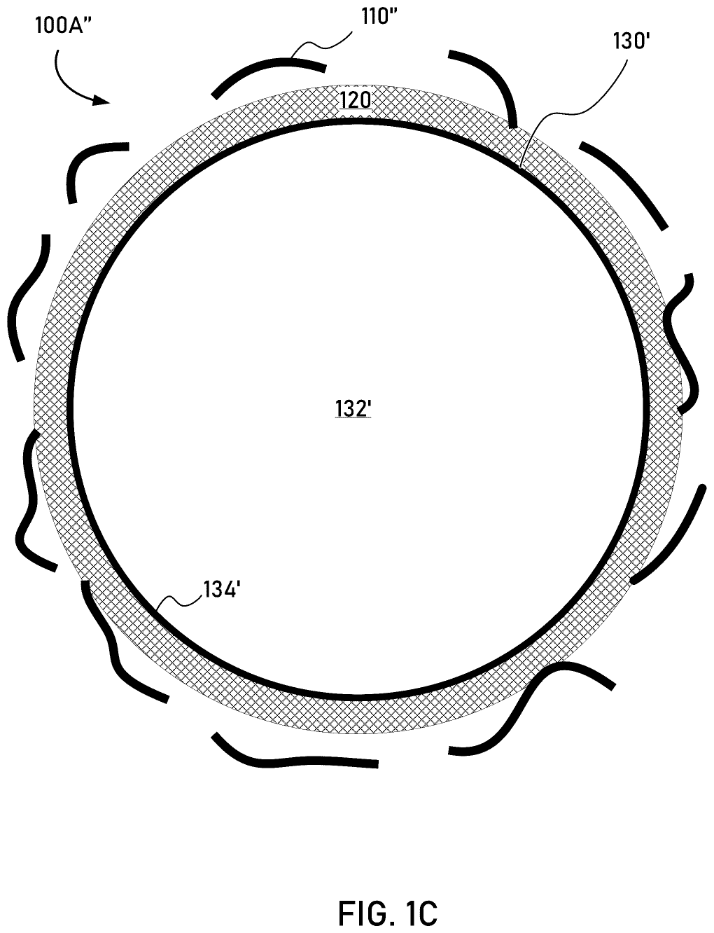

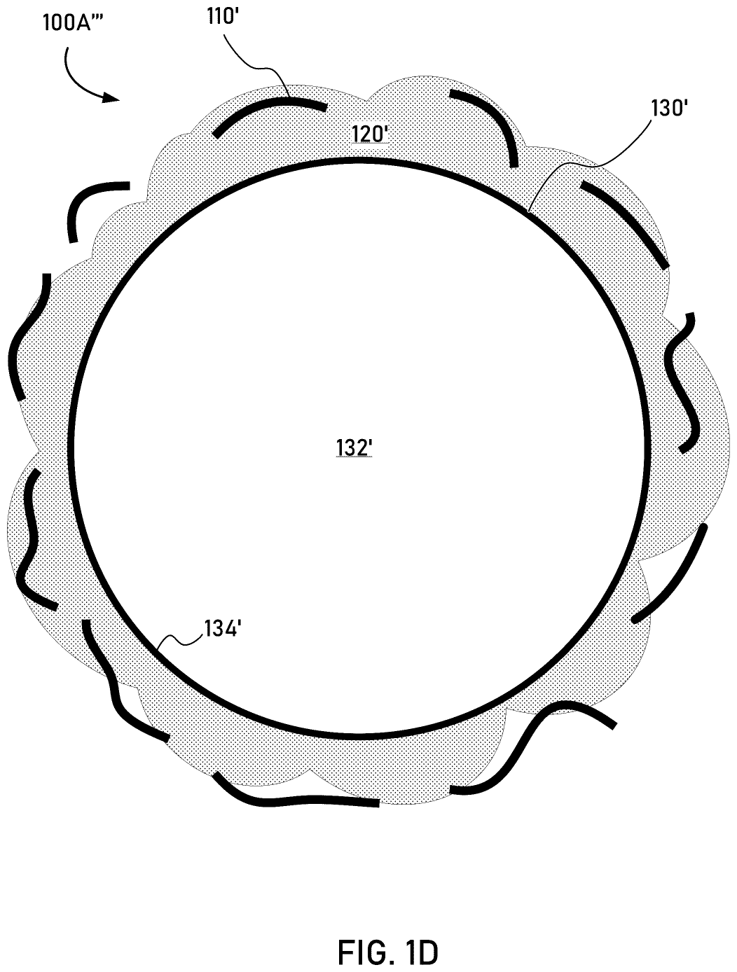

FIGS. 1A-ID illustrate cross-sectional views of a first embodiment of a microcapsule 100A, according to embodiments of the present disclosure. FIG. 1A illustrates the microcapsule 100A in a first stage, FIG. 1B illustrates the microcapsule 100A′ in a second stage, FIG. 1C illustrates the microcapsule 100A″ in a third stage, and FIG. 1D illustrates the microcapsule 100A′″ in a fourth stage, according to embodiments of the present disclosure.

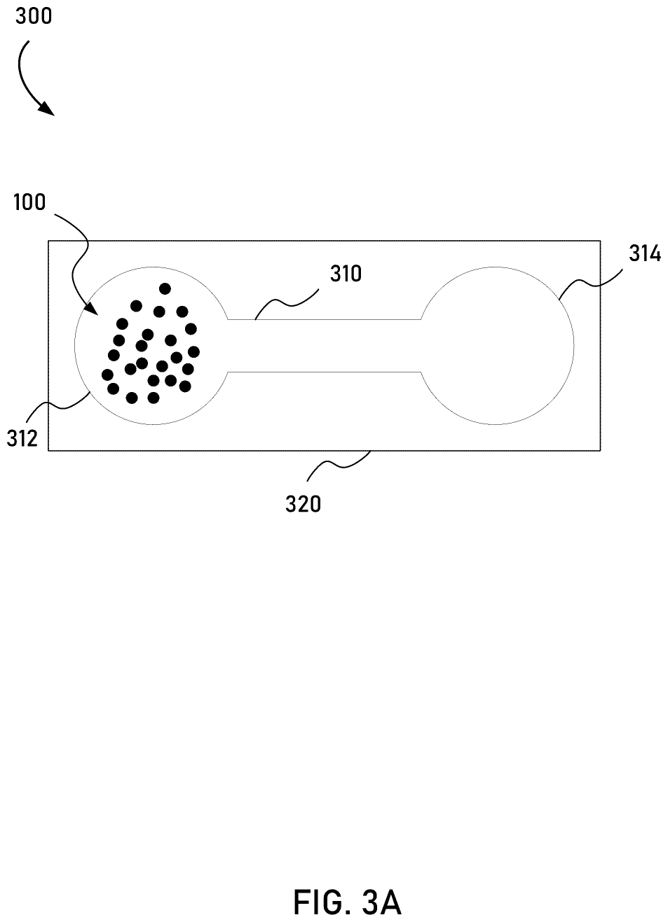

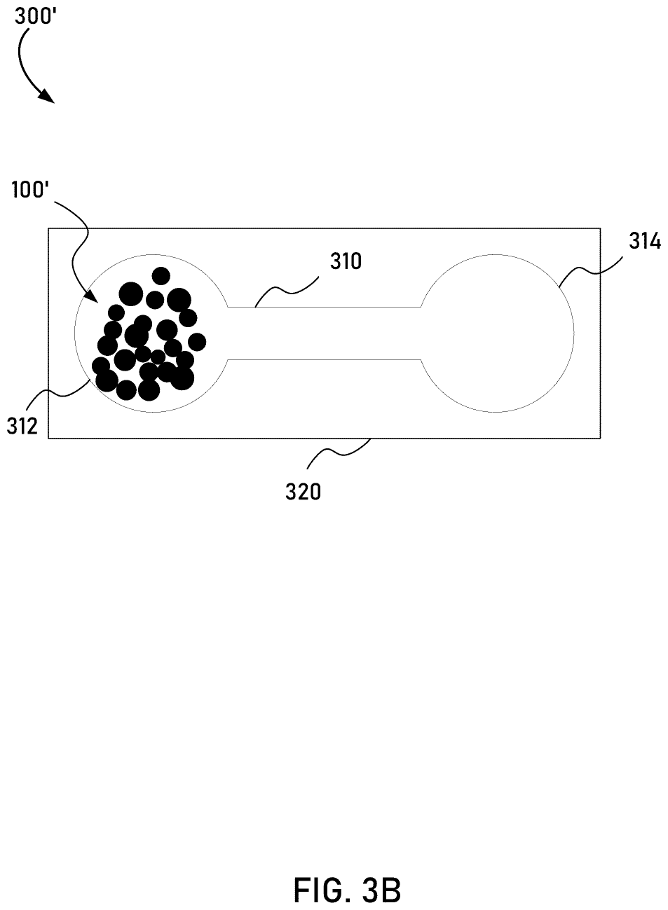

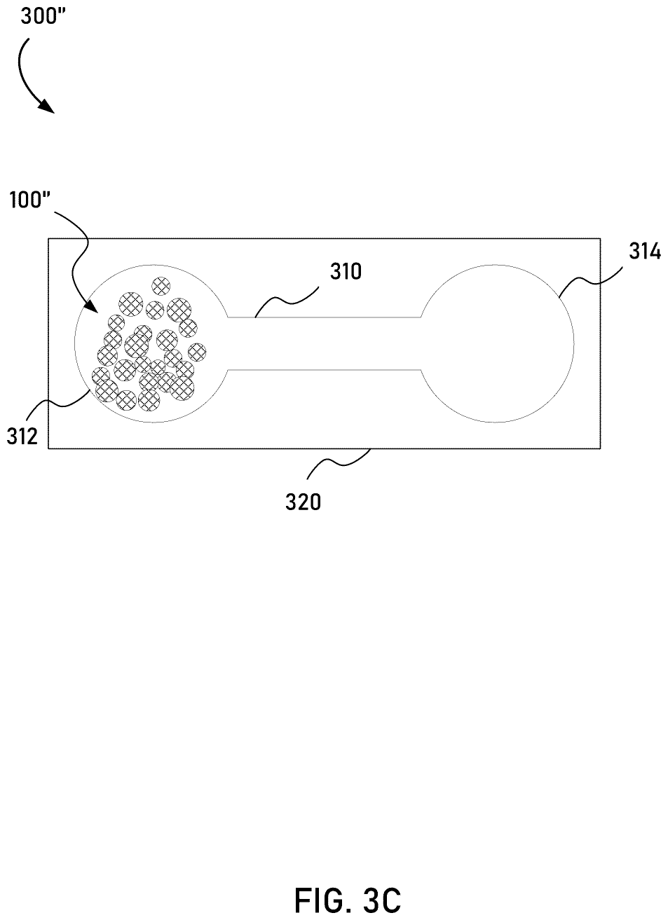

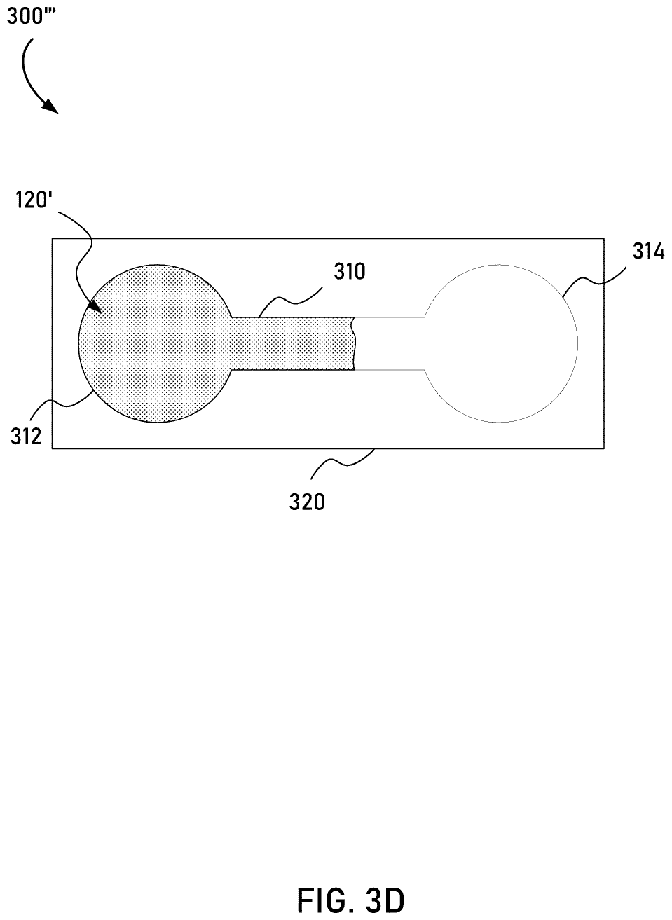

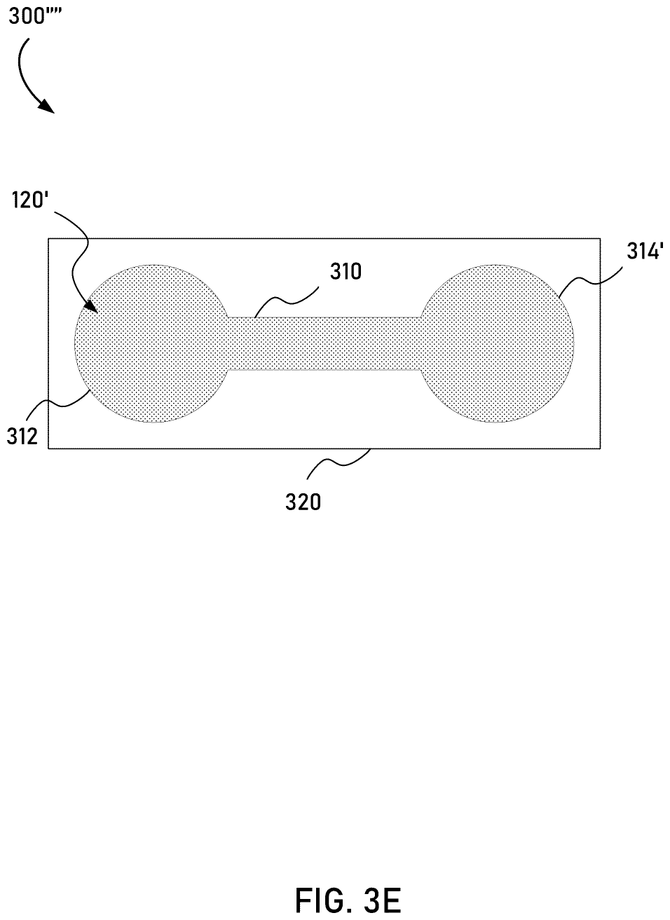

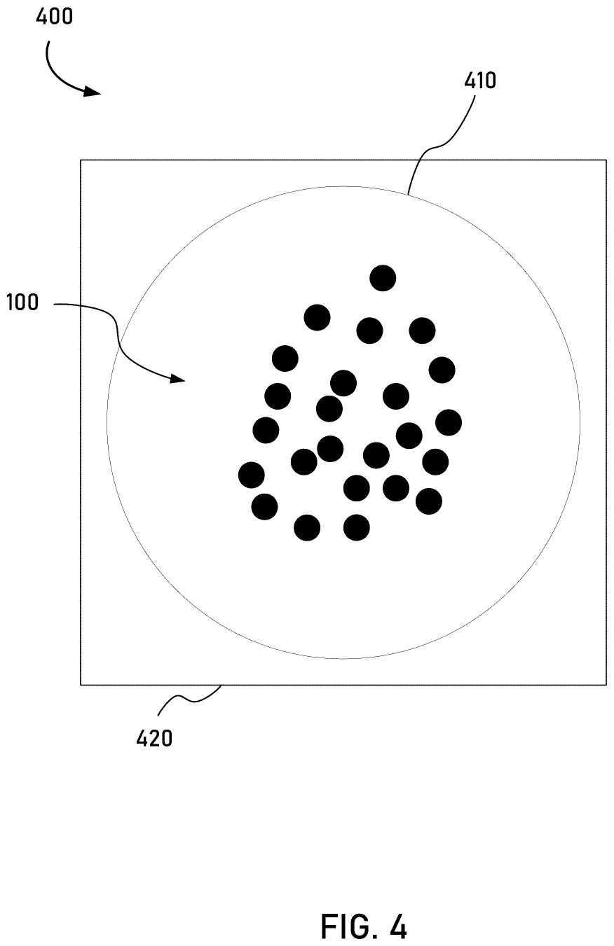

According to some embodiments, the microcapsule 100A includes a frangible shell 110. The frangible shell 110 may contain a payload 120, and a thermally expandable microsphere 130. The thermally expandable microsphere 130 has an expandable shell 134 that contains a volatile material 132. The payload 120 includes at least a liquefiable material, which in some examples may be as described above in Section I. In some examples, the payload 120 includes a liquifiable material combined with an indicator material, which may be configured to produce an effect (e.g., cither alone or in tandem with elements of an indicator (see FIGS. 3A-4D) when the liquefiable material transitions from a solid phase to a liquid phase.

With respect to the payload 120, in some examples, the liquifiable material forms a solid matrix when in the solid phase, such that indicator material is embedded within a matrix formed by the liquefiable material. When the liquefiable material liquefies, the liquefiable material may act as a transport material with respect to the indicator material. When liquefiable material liquefies, the indicator material is released from the matrix and movement of the indicator material is facilitated through the liquefied liquifiable material. Furthermore, the when the liquefied liquefiable material is acted upon (e.g., by wicking action, capillary action, gravity or other forces) and compelled to motion, the liquefied liquifiable material may transport the indicator material as the liquefiable material moves.

In the present disclosure, the payload 120 includes a sufficient proportion of the liquefiable material that when the liquefiable material liquefies, the payload as a whole, notwithstanding suspended or contained solids (e.g. indicator materials) being contained therein, substantially acts as a liquid. Thus, throughout the disclosure the payload 120 may be said to liquefy. It is understood that reference to the payload 120 liquefying or being liquefied (e.g., and other variations across parts of speech) indicates only that the liquefiable material within the payload 120 is liquefied. Such language does not imply or indicate that the payload 120 does not contain or include non-liquid materials, nor does such language indicate that any material within the payload 120 apart from the liquefiable material is necessarily liquefied.

The microcapsule 100A may be any size, but in one such embodiment, has an outer diameter length between 20 to 1000 micrometers (μm). The frangible shell 110 may be any size smaller than or equal to the outer diameter of the microcapsule 100A. The frangible shell 110 can have a thickness of between 5 to 25 μm. The ratio of the total weight of the contents (e.g. thermally expandable microsphere 130, payload 120) within the microcapsule 100A to the entire weight of the microcapsule 100A including the contents contained within the microcapsule 100A, can range from 50 percent to 90 percent. A variety of frangible shell 110 materials may be chosen, depending on the application, and the nature of the contents of the microcapsule 100A. In general, the frangible shells 110 should resist the passage, whether by flow, diffusion, or migration, of the contents of the microcapsule 100A, prior to activation.

Generally speaking, the microcapsule 100A is configured to be activated responsive to an application of an activation action, or in some examples, two activation actions. When activated, the frangible shell 110 of the microcapsule 100A is disengaged, such that the payload 120 of the microcapsule 100A is exposed to the environment. When the payload 120 is exposed to the environment, an exposure to the predetermined environmental exposure causes the payload 120 to transition to the liquid state. In this manner, when the payload is exposed to the environment, the payload is primed to begin sensing, or is environmentally sensitive.

The thermally expandable microsphere 130 serves as at least one mechanism for activation. Responsive to the application of an activation action (e.g., first activation action), the thermally expandable microsphere 130 expands within the frangible shell 110 of the microcapsule 100A, which weakens or ruptures the frangible shell 110. When the activation action is a heat exposure (e.g., an exposure to a temperature which heats the microsphere above the predetermined activation temperature) the volatile material 132 in the thermally expandable microsphere 130 volatilizes and transitions to a gas (e.g., gaseous phase), causing the thermally expandable microsphere 130 to expand, inducing an internal pressure on the frangible shell 110 of the microcapsule 100A.

In some examples, the activation action and the predetermined environmental exposure may be of the same type, e.g., the activation action is an exposure to a temperature above a first predetermined (activation) temperature threshold for at least a first predetermined duration, and the predetermined environmental exposure is an exposure to a temperature above a second predetermined (exposure) temperature threshold for at least a second predetermined duration. In such cases, the microcapsule 100A may be configured such that the first temperature threshold is above the second temperature threshold, and the second predetermined duration is greater than the first predetermined duration. In this manner, a rapid pulse (e.g., low duration) at a temperature above the first threshold (and the second temperature threshold) may be provided as an activation action. The pulse is of sufficient duration to volatilize or otherwise trigger the expansion of the volatile material 132, while being of insufficient duration to cause the payload 120 to liquefy. In some examples, the first predetermined temperature threshold (e.g., activation threshold temperature) is defined within a range bounded by 50 degrees C. and 350 degrees C. In some examples, the first predetermined duration (e.g., activation threshold duration) is defined within a range bounded by 1 millisecond and 5 seconds. In some examples, the second predetermined threshold temperature (predetermined threshold temperature) is defined within a range bounded by −15 degrees C. and 35 degrees C. In some examples, the second predetermined duration (predetermined cumulative period of time) is greater than 1 second.

In some examples the microcapsule 100A requires a second activation action, to complete activation. In such examples, the first activation action may cause the payload 120 to transition to the liquid state without impairing the function of the microcapsule. As an example, the first activation section may be provided by an exposure to a temperature above a first predetermined temperature threshold, and the second activation action may be a subsequent exposure to a compressive stress exceeding a predetermined stress threshold. The predetermined environmental exposure may be an exposure to a temperature above a second predetermined temperature threshold. In such an embodiment, the first temperature threshold may be in excess of the second temperature threshold, as the frangible shell 110 would remain intact until the application of the second activation action (e.g., the compressive stress). Thus, if the first activation action is sufficient to cause the payload 120 to liquefy, the second activation may be delayed until such a time as the microcapsule 100A returns below the second temperature threshold, and the payload 120 re-solidifies (e.g., in embodiments where liquefaction of the payload 120 is reversible).

In some examples, the activation action and the second activation action are applied simultaneously to activate the microcapsule 100A, and in other examples the activation action and the second activation action are applied separately and consecutively. In some examples, activation is contingent on the second activation action being applied subsequently to the first, or vice versa.

According to some embodiments, the expandable shell 134 of the thermally expandable microsphere 130 may be formed entirely or in part by a thermoplastic or resin, which is configured to facilitate the expansion of the volatile material 132 (e.g., once activated) while remaining intact. In some examples, the expandable shell 134 may be configured to isolate the volatile material 132 from the payload 120 within the microcapsule 100A. This feature may be gainfully utilized in embodiments where the volatile material 132 is potentially reactive with an indicator material in the payload 120 or with the liquefiable material. In some examples, the expandable shell 134 may also prevent the volatile material 132 from dispersing into the payload 120 and potentially disrupting the function thereof when expanding.

According to some embodiments, the thermally expandable microsphere 130 contained in each microcapsule 100A has a volume that is between 1% and 20% of a volume of the microcapsule before the thermally expandable microsphere is activated (e.g., expands).

In some examples, the indicator material is a dye, or chemical pigment, such as a leuco dye, or other plurality of colored particles carried by the carrier material. In some examples the indicator material is a flash material, which gives off a bright appearance when illuminated with light of a specified wavelength. In some examples, the indicator material is a plurality of conductive particles, or conductive material. In some examples, the indicator material may be one or more chemical reactants, configured to produce a color-state changing chemical reaction when exposed to another chemical reactant. In some such examples, a first of the chemical reactants may be disposed in the payload 120 and a second of the chemical reactants may be disposed in a receiving location, (e.g., indicator region, Sec. FIGS. 3A-3E), such that when the payload 120 reaches the receiving location the first and second chemical reactants react, producing a color state change. In other such examples, the first of the chemical reactants is disposed in a first plurality of microcapsules, and the second of the chemical reactants is disposed in a second plurality of microcapsules, and the first and second chemical reactants produce the color state changing reaction when the first and second pluralities of microcapsules are activated.

Generally speaking, the indicator material may include dyes, leuco dyes, a color forming agent, a color developing agent, chemical pigments, particles containing copper, particles containing silver, particles containing graphite, particles containing conductive metals, particles containing conductive non-metal materials, and combinations thereof.

FIG. 1A illustrates a first stage of the microcapsule 100A, in which the microcapsule 100A has yet to be exposed to the activation action(s). In the first stage, previous or concurrent exposures to the predetermined environmental exposure are nonconsequential, as the frangible shell 110 contains the payload 120 when in both the liquid phase and the solid phase. Prior to activation, the thermally expandable microsphere 130 has an initial size, (e.g., unexpanded size, small size).

FIG. 1B illustrates a second stage of the microcapsule 100A′ at a point in time during the activation process, as the microcapsule 100A′ transitions from the unactivated state to the activated state, according to embodiments of the present disclosure. In embodiments where the microcapsule 100A is activatable responsive to the application of two activation actions, the second stage is the state in which the microcapsule 100A′ is in following the application of the first application action, but prior to the application of the second activation action. In embodiments where the microcapsule 100A is activatable responsive to one activation action, the second stage is the state in which the microcapsule 100A′ is in at a point in time prior to the completion of the response of the microcapsule 100A′ to the application of the activation action.

The microcapsule 100A is configured to be activated responsive to the application of an activation action (or activation actions). The volatile material 132′ is configured to expand (e.g., volatilize) responsive to the application of the activation action. When the thermally expandable microsphere 130′ expands (e.g., responsive to the volatilization of the volatile material 132′), the frangible shell 110 is subjected to internal pressure forces resulting from the expansion of the thermally expandable microsphere 130′ within the frangible shell 110′. As illustrated in FIG. 1B, the expansion of the thermally expandable microsphere 130 causes a substantial expansion of the microcapsule 100A. While the expansion of the thermally expandable microsphere 130 may cause a substantial expansion of the microcapsule 100A, the expansion of the microcapsule 100 may be dependent of the material chosen for the frangible shell 110. In embodiments where the frangible shell 110 material is more brittle, the microcapsule 100A will rupture at a smaller size than embodiments in which the frangible shell 110 is formed of more elastic material(s). Various embodiments of the present disclosure contemplate where the microcapsule 100A may rupture with very little expansion of the frangible shell 110 responsive to the expansion of the thermally expandable microsphere 130, and other embodiments contemplate where the microcapsule 100A expands by up to 1000% in volume prior to rupture.

In examples in which the microcapsule 100A is activatable responsive to the application of two activation actions, the frangible shell 110′ is configured such that the expansion of the thermally expandable microsphere 130 weakens but does not rupture the frangible shell 110′. When the thermally expandable microsphere 130 expands, the expandable shell 134′ of the microsphere thins with the expansion but does not rupture.

In some examples, the thermally expandable microsphere 130 has a volume that is between 100% and 1000% of a volume of the microcapsule 100A after the thermally expandable microsphere 130′ expands responsive to the activation action (e.g., first activation action).

FIG. 1C illustrates a third stage of the microcapsule 100A″ at a point in time where activation is completed, but the microcapsule 100A has not been exposed to the predetermined environmental exposure following activation. In the third stage the microcapsule 100A″ is activated (e.g., whether by one activation action or two) and is primed to begin environmental sensing (e.g., the payload 120 will no longer be contained when liquefied). In the third stage, the frangible shell 110″ is ruptured by internal pressure forces resulting from the expansion of the thermally expandable microsphere 130 within the frangible shell 110″.

FIG. 1D illustrates a fourth stage of the microcapsule 100A′″, following both activation and a subsequent exposure to the predetermined environmental exposure, according to embodiments of the present disclosure. As the payload 120 is exposed to the environment by activation of the microcapsule 100A′″, upon exposure to the predetermined environmental exposure, the payload 120′ liquefies. The predetermined environmental exposure may be one of a temperature excursion above a second predetermined temperature, a temperature excursion above a second predetermined temperature threshold for at least a predetermined amount of time, a temperature excursion below a second predetermined temperature, a temperature excursion below a second predetermined temperature for at least a predetermined amount of time, cumulative exposure to a second predetermined temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time, combinations thereof, and the like.

### Activatable Microcapsule: Second Embodiment

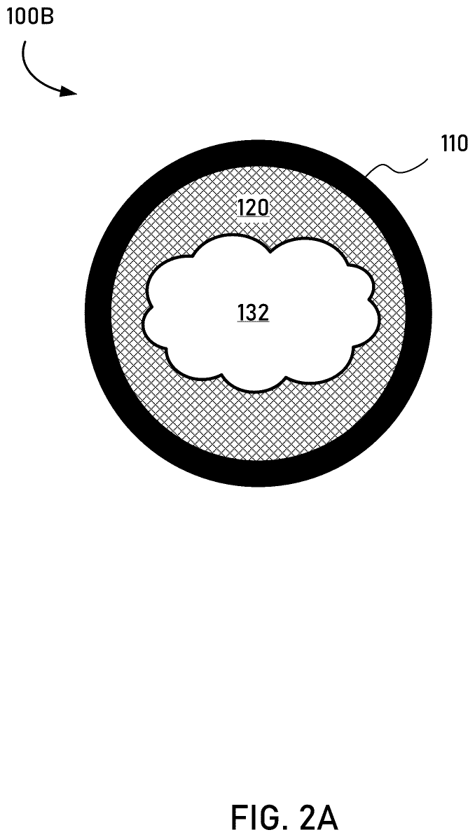

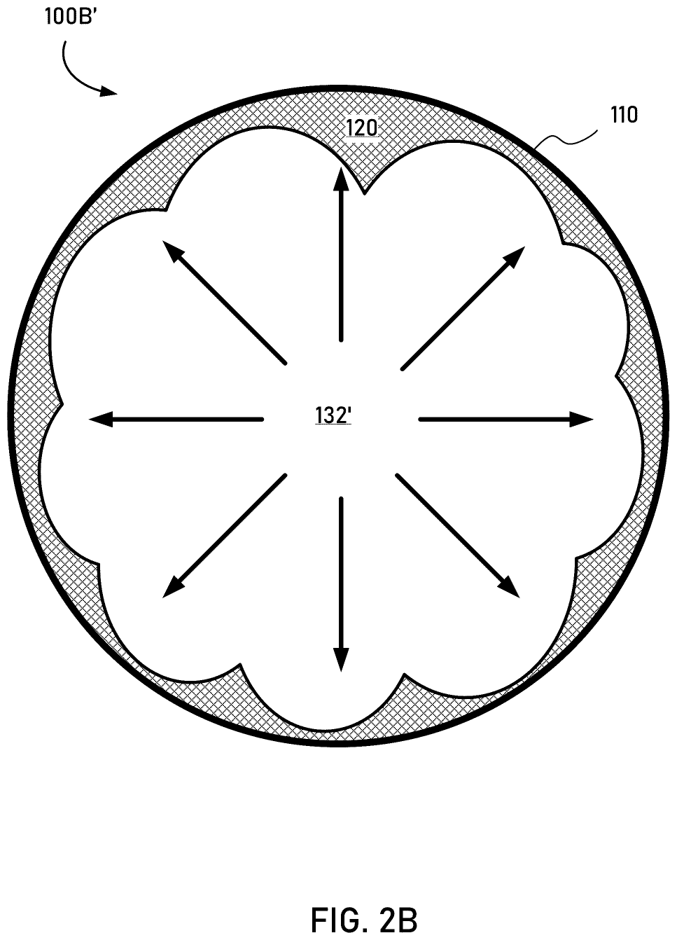

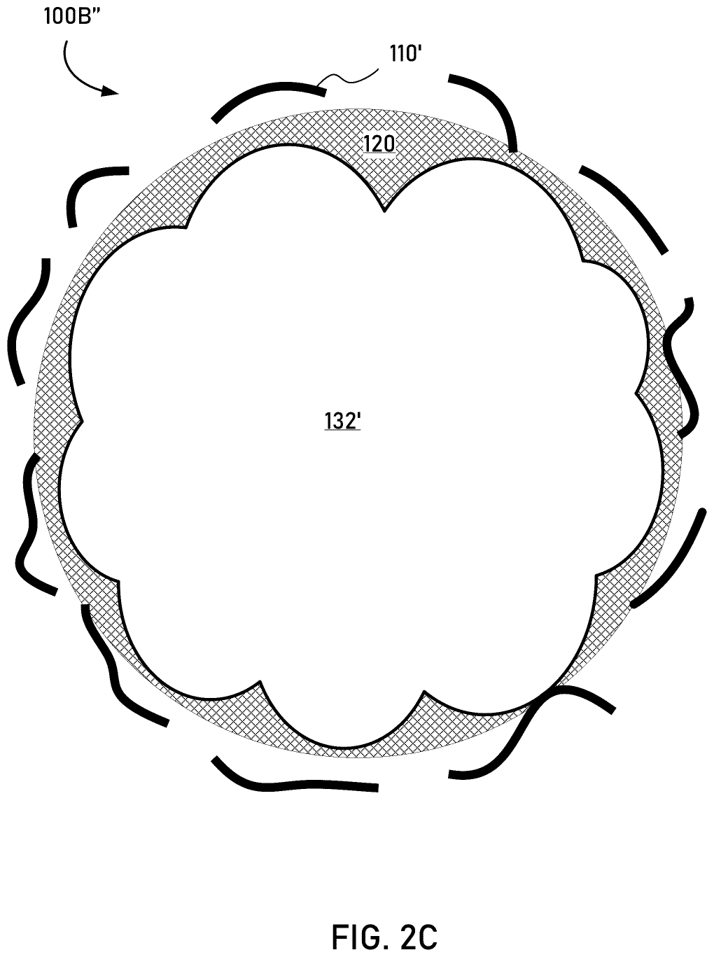

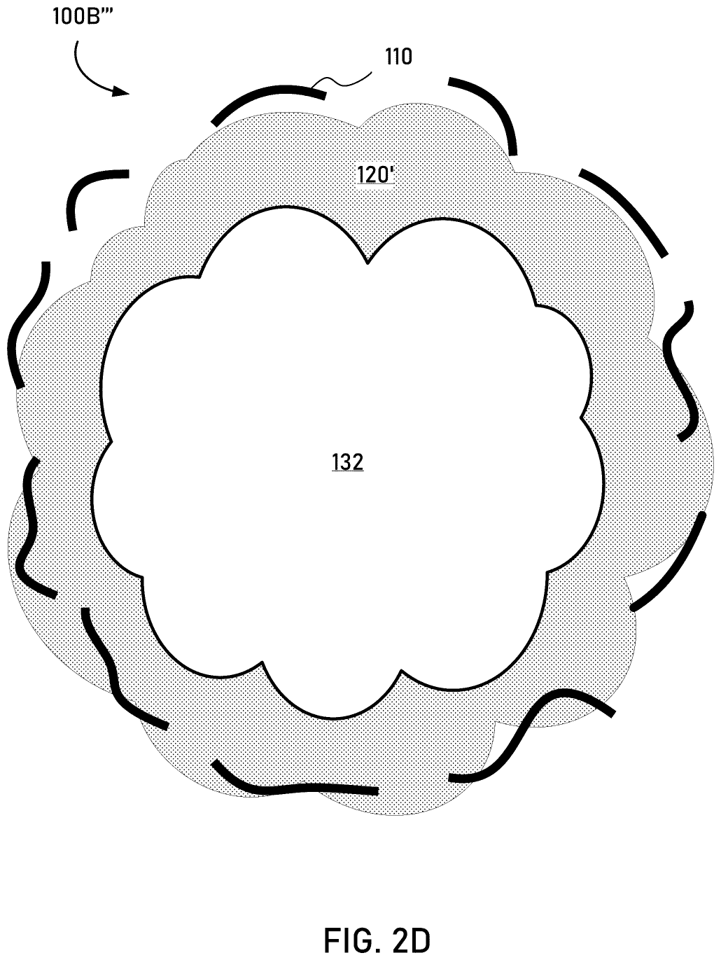

FIGS. 2A-2D illustrate cross-sectional views of a first embodiment of a microcapsule 100B, according to embodiments of the present disclosure. FIG. 2A illustrates the microcapsule 100B in a first stage, FIG. 2B illustrates the microcapsule 100B′ in a second stage, FIG. 2C illustrates the microcapsule 100B″ in a third stage, and FIG. 2D illustrates the microcapsule 100B′″ in a fourth stage, according to embodiments of the present disclosure.

According to some embodiments, the microcapsule 100B includes a frangible shell 110. The frangible shell contains a payload 120, and a volatile material 132. The payload 120 includes at least a liquefiable material, which in some examples may be as described above in Section I. In some examples, the payload 120 includes a liquifiable material combined with an indicator material. The indicator material may be configured to produce an effect (e.g., either alone or in tandem with elements of an indicator, see FIGS. 3A-4D) when the liquefiable material transitions from a solid phase to a liquid phase (e.g., liquefies).

According to some embodiments, the microcapsule 100B possesses the same features, properties, and attributes as the microcapsule 100A, excepting those features, properties and attributes relating to the expandable shell 134 of the thermally expandable microsphere 130.

FIG. 2A illustrates a first stage of the microcapsule 100B, in which the microcapsule 100B has yet to be exposed to the activation action(s). In the first stage, previous or concurrent exposures to the predetermined environmental exposure are nonconsequential, as the frangible shell 110 contains the payload 120 when in both the liquid phase and the solid phase. Prior to activation, the volatile material 132 has an initial volume, (e.g., unexpanded volume, small volume).

FIG. 2B illustrates a second stage of the microcapsule 100B′ at a point in time during the activation process, as the microcapsule 100B′ transitions from the unactivated state to the activated state, according to embodiments of the present disclosure. In embodiments where the microcapsule 100B is activatable responsive to the application of two activation actions, the second stage is the state in which the microcapsule 100B′ is in following the application of the first application action, but prior to the application of the second activation action. In embodiments where the microcapsule 100B is activatable responsive to one activation action, the second stage is the state in which the microcapsule 100B′ is in at a point in time prior to the completion of the response of the microcapsule 100B′ to the application of the activation action.

The microcapsule 100B is configured to be activated responsive to the application of an activation action (or activation actions). The volatile material 132′ is configured to expand (e.g., volatilize) responsive to the application of the activation action. When the volatile material 132′ expands, the frangible shell 110 is subjected to internal pressure forces resulting from the expansion of the volatile material 132′ within the frangible shell 110′. As illustrated in FIG. 2B, the expansion of the volatile material 132 causes a substantial expansion of the microcapsule 100B. While the expansion of the volatile material 132 may cause a substantial expansion of the microcapsule 100B, the expansion of the microcapsule 100 may be dependent of the material chosen for the frangible shell 110. In embodiments where the frangible shell 110 material is more brittle, the microcapsule 100B will rupture at a smaller size than embodiments in which the frangible shell 110 is formed of more clastic material(s). Various embodiments of the present disclosure contemplate where the microcapsule 100B may rupture with very little expansion of the frangible shell 110 responsive to the expansion of the volatile material 132, and other embodiments contemplate where the microcapsule 100B expands by up to 1000% in volume prior to rupture.

In examples in which the microcapsule 100B is activatable responsive to the application of two activation actions, the frangible shell 110′ is configured such that the expansion of the volatile material 132′ weakens but does not rupture the frangible shell 110′.

FIG. 2C illustrates a third stage of the microcapsule 100B″ at a point in time where activation is completed, but the microcapsule 100B has not been exposed to the predetermined environmental exposure following activation. In the third stage the microcapsule 100B″ is activated (e.g., whether by one activation action or two) and is primed to begin environmental sensing (e.g., the payload 120 will no longer be contained when liquefied). In the third stage, the frangible shell 110″ is ruptured by internal pressure forces resulting from the expansion of the volatile material 132′ within the frangible shell 110″.

FIG. 2D illustrates a fourth stage of the microcapsule 100B′″ following both activation and a subsequent exposure to the predetermined environmental exposure, according to embodiments of the present disclosure. The payload 120 is exposed to the environment by activation of the microcapsule 100B″. Upon exposure to the predetermined environmental exposure, the payload 120′ liquefies. The predetermined environmental exposure may be one of a temperature excursion above a second predetermined temperature, a temperature excursion above a second predetermined temperature threshold for at least a predetermined amount of time, a temperature excursion below a second predetermined temperature, a temperature excursion below a second predetermined temperature for at least a predetermined amount of time, cumulative exposure to a second predetermined temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time, combinations thereof, and the like.

### Section III: Embodiments of Activatable Environmental Exposure Indicators

### Activatable Environmental Exposure Indicator: First Embodiment

FIG. 3A illustrates an indicator 300, which may serve as a platform for the several examples of environmentally sensitive indicators disclosed herein, according to embodiments of the present disclosure. FIGS. 3A-3D illustrate various states of the indicator 300, according to embodiments of the present disclosure. Generally, an indicator 300 includes a wick 310, which may be formed of a wicking material, disposed on a substrate 320. An activation region 312, containing microcapsules 100 (e.g., microcapsules 100A or microcapsules 100B), may be disposed proximately to the wick 310. In some examples, the activation region 312 containing the microcapsules 100 is disposed on the wick 310. The indicator 300 may further include an indicator region 314, where an observable change may occur when the indicator 300 responds to a predetermined environmental exposure. In FIGS. 3A-3D, the wick 310 is illustrated as having a “dog bone” shape, however this disclosure contemplates embodiments where the wick 310 has other forms and shapes. In FIGS. 3A-3D, the activation region 312 and the indicator region 314 are illustrated as being portions of the wick 310, the indicator region 314 opposite to the activation region 312, however this disclosure contemplates embodiments where the activation region 312 and the indicator region 314 have other forms and shapes, including those where the activation region and the indicator region overlap, or are the same region (e.g., time-independent indicators). Non-limiting examples of contemplated indicator regions 314 and activation regions 312 include a demarcated portion of a wick 310, a non-demarcated portion of the wick 310, the entirety of the wick 310, an area proximate to the wick 310, a reservoir or containment volume disposed proximately to the wick 310, and the like.

In some examples, the wick 310 may be formed from a wicking material, which may include woven polyester, nonwoven polyester, polyamide and blended elastane and polyester, carbon fiber, Teslin synthetic paper, polyethylene, polypropylene, polytetrafluoroethylene, woven nylon, or any material suitable to draw water from a medium by capillary action.

In some examples, the substrate 320 may be made with a paper or polyethylene terephthalate (PET). In other examples, the substrate may be made with any other suitable non-conductive material or any breathable film, such as cloth or plastic (e.g., polyethylene terephthalate (PET), polyvinyl chloride (PVC), polyvinyl acetate (PVAC), etc.).

In some embodiments, the microcapsules 100 are coupled to the activation region 312, or wick 310 (in applicable embodiments), by a bonding material in which the microcapsules are contained or embedded. The bonding material may serve as a means of dispensation (e.g., during manufacture of the indicator 300) and a means of retaining the microcapsules 100 to the indicator 300 prior to use.

FIG. 3A illustrates the unactivated state of the indicator 300, according to embodiments of the present disclosure. In the unactivated state, the frangible shells 110 of the microcapsules 100 are intact, and contain the payload 120, irrespective of whether the payload 120 is liquefied or solidified. In the unactivated state, the indicator region 314 is in a first state. The first state indicates that the indicator 300 has not been exposed to the predetermined environmental exposure.

FIG. 3B illustrates the indicator 300′ in at a point in time during the activation process, as the indicator 300′ transitions from the unactivated state to the activated state, according to embodiments of the present disclosure. In embodiments where the microcapsules 100 are rupturable responsive to the application of two activation actions, FIG. 3B illustrates the state in which the indicator 300′ is in following the application of the first application action, but prior to the application of the second activation action. In embodiments where the microcapsules 100 are activatable responsive to one activation action, FIG. 3B illustrates the state in which the indicator 300′ is in at a point in time prior to the completion of the response of the microcapsules 100′ to the application of the activation action.

According to some embodiments, the activation action (e.g., the first activation action in some embodiments) is an exposure to a temperature above a first predetermined temperature threshold for at least a first predetermined duration.

FIG. 3C illustrates an activated and unexposed state of the indicator 300″, according to embodiments of the present disclosure. When the indicator 300, or more specifically, the microcapsules 100″, are exposed to the activation action (e.g., or the first and second activation actions), the microcapsules 100″ rupture, releasing the payload 120. When the microcapsules 100 rupture, the indicator 300″ is “activated.” When the indicator 300″ is activated, liquefaction of the payload 120 responsive to the predetermined environmental exposure causes the migration of the liquefied payload 120 into the wick 310. However, in the activated and unexposed state, the indicator 300 has yet to be exposed to the predetermined environmental exposure. Thus, the payload 120 is in the solid phase and is not drawn into the wick 310. In the activated and unexposed state, the indicator region 314 is in a first state, as the payload 120 is not present in the indicator region 314 to produce the observable effect.

FIG. 3D illustrates an activated and exposed state of the indicator 300, according to embodiments of the present disclosure. After the microcapsules 100 have been activated, the payload 120 is released from the microcapsule. When the indicator 300 is subsequently exposed to the predetermined environmental exposure, the payload 120 liquefies and migrates into the wick 310. The liquefied payload 120 may be drawn into the wick 310 via wicking action or capillary action, and the indicator material may saturate (e.g., partially, or fully), fill, or otherwise permeate pores of the wick. The indicator 300 is configured such that the payload 120 migrates along the wick 310, or progressively saturates the wick 310, until the payload 120 reaches the indicator region 314 (see FIG. 3E). FIG. 3D illustrates a transitional period of the indicator where the payload 120 has yet to reach the indicator region 314.

In some examples, the wick 310 may act as a filter, such that the liquefied payload 120 is drawn into the wick, but the thermally expandable microspheres 130′ and ruptured frangible shells 110″ remain in the activation region 312, being too large to pass into the pores of the wick 310.

In some examples, the indicator 300 is configured to indicate exposure to a second predetermined environmental exposure for a predetermined amount of time. In such embodiments, the payload 120 may solidify responsive to a cessation of the predetermined environmental exposure. In such embodiments, the wick 310 may be configured such that the payload 120 must be in a liquid state for a predetermined amount of time to fully migrate through the wick 310 and reach the indicator region 314.

In some examples, the payload 120 may liquefy and solidify responsive to successive exposures and cessation of the predetermined environmental exposure, and the payload 120 reaches the indicator region 314 after a cumulative amount of time in which the indicator is exposed to the predetermined environmental exposure reaches a predetermined threshold. In such examples, the wick 310 may be configured to have a specific length, such that the indicator 300 is time-dependent. A wick 310 of increased length (e.g., an increased distance between the portion of the wick on which the bonding material is disposed and the indicator region 314) may provide for a longer time-dependency, as the payload 120 would have a greater distance to travel to reach the indicator region 314. Time-dependency may also be tuned by adjusting the viscosity of the payload 120, as a more viscous payload 120 may wick slower than a less viscous payload 120. Generally speaking, the wick may be configured such that indicator material migrates along the wick at a predetermined rate when the portion of the indicator material is liquified, and the indicator material reaches the indicator region after a predetermined period of time and produces the observable effect.

FIG. 3E illustrates an activated and exposed state of the indicator 300, where the payload 120 has reached the indicator region 314, according to embodiments of the present disclosure. When the payload 120′ reaches the indicator region 314′, the payload 120′ produces an observable effect in the indicator region 314′.

In some examples, the payload 120′ has a color state that is visibly distinct from the color state of the indicator region 314, such that when the payload 120′ reaches the indicator region 314′ the presence of the payload 120′ is the observable effect. In such examples, the color state of the indicator material may be dependent upon the indicator material contained in the payload 120′, which may include a chemical pigment, ink, or dye.

In some examples, the indicator material 120′ may reveal or obscure an indicium in the indicator region 314′. In such examples, the indicium to be obscured or revealed may have a color state distinct or contrasted from the color state of the payload 120′, such that the indicium appears to undergo a change of color state when the payload 120′ migrates into the indicator region 314′. In some examples, when the indicum is revealed, the indicum includes a symbol, image, or natural language text.

As a non-limiting illustrative example, the indicator region 314′ may include a saturable indium having the form of an “X” (e.g., to indicate exposure to the predetermined environmental exposure) and having a color state that does not visually contrast the substrate 320 such that the “X” is not readily viewable to an observer. The payload 120 includes an indicator material having a color state that visually contrasts the substrate 320, such that when the payload 120′ reaches the indicator region 314′, the payload 120′ saturates the indicum, and the “X” becomes readily viewable to the observer.

In some examples, the indicator region 314 includes a first chemical reactant, configured to react with a second chemical reactant contained in or comprising the indicator material in the payload 120, such that when the payload 120 reaches the indicator region 314′, the second chemical reactant in the indicator material reacts with the first chemical reactant, and produces a chemical product, where the chemical product or the chemical reaction creates an observable effect. In such examples, the chemical product may have a color state that is visibly distinct from the payload 120 and the indicator region 314. In some examples, the first chemical reactant forms the indicia. In such examples, the indicia may not initially be visible to an observer, or has a first color state, and subsequently becomes visible, or changes color state, upon contact with the second chemical reactant contained in the indicator material.

In some examples, the payload 120 includes conductive materials which are configured to change an electrical property of the indicator region 314. In such examples, the indicator region 314 may have a first electrical property (e.g., a first measured value of one or more of resistance, capacitance, conductivity, and impedance) when the payload 120 is not in the indicator region 314, and have a second electrical property (e.g., a second measured value of one or more of resistance, capacitance, conductivity, and impedance) when the payload 120 is in the indicator region 314. The electrical property may be monitored across the indicator region 314 by a circuit, and the change from the first electrical property to the second electrical property when the payload 120 reaches the indicator region 314 induces a change in behavior of the circuit, which may be observed by a user. Stated differently, the observable effect produced by the payload 120 reaching the indicator region 314 is the change from the first electrical property to the second electrical property. In some examples the conductive materials may include particles containing copper, particles containing silver, particles containing graphite, particles containing conductive metals, particles containing conductive non-metal materials, and combinations thereof.

Generally speaking, the observable effect (e.g., observable change) produced in the indicator region 314 may be a change of reflectivity, a change in transparency, a change in hue, a change in chroma, a change in apparent color, a change in conductivity, a change in resistance, a change in impedance, a change in capacitance, and combinations thereof.

In some examples, the indicator 300 includes a laminating layer, such that the wick 310 and microcapsules 100 are secured and contained between the substrate and the laminating layer. In some examples, the laminating layer includes one or more windows, such that one or more of the indicator regions 314, the activation region 312 and the wick are viewable through the laminating layer. According to some embodiments, the windows may be formed by removed portions of the laminating layer, or transparent (e.g., or substantially transparent) portions of the laminating layer. According to some embodiments, the laminating layer or the substrate may be partially or entirely transparent.

### Activatable Environmental Exposure Indicator: Variant Embodiments

FIG. 4 illustrates an indicator 400, according to embodiments of the present disclosure. The indicator 400 is a single excursion indicator configured to indicate a one-time exposure to a predetermined environmental exposure. The indicator 400 includes a substrate 420 and a plurality of activatable microcapsules 100 disposed in a sensing region 410. The indicator 400 differs from the general embodiment of the indicator 300 as the sensing region 410 serves as both as an activation region and an indicator region. As the indicator 400 is a single excursion indicator, the indicator 400 is not time dependent, and therefore does not include a wick. The microcapsules 100 are activatable in the sensing region 410, and the payload 120 contained within the microcapsules is configured to produce the observable effect within the sensing region 410.

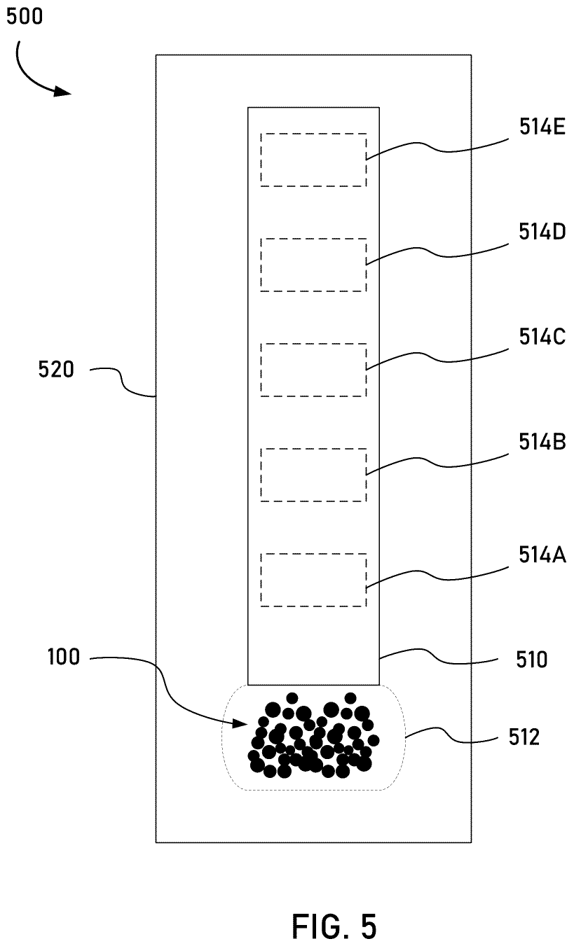

FIG. 5 illustrates a progressive indicator 500, according to embodiments of the present disclosure. Similar to the general embodiment, the progressive indicator 500 includes a wick 510, a substrate 520 and an activation region 512. The progressive indicator 500 further includes several indicator regions 514A-E. The progressive indicator 500 is configured to indicate the cumulative exposure of the progressive indicator 500 to a predetermined environmental exposure. Following activation, the payload 120 liquefies and begins to migrate along the wick 510, and each successive indicator region 514 is configured to indicate (upon the payload 120 reaching each indicator region 514) a predetermined duration of exposure to the predetermined environmental exposure.

In some examples, the payload 120 may liquefy and solidify responsive to successive exposures and cessation of the predetermined environmental exposure, and the payload 120 reaches a given indicator region 514 after a cumulative amount of time in which the indicator is exposed to the predetermined environmental exposure reaches a predetermined threshold. In such examples, the indicator regions 514 may be configured to have a predetermined distance therebetween. A greater distance may provide for a longer time-dependency, as the payload 120 would have a greater distance to travel to reach the next indicator region 514. Time-dependency may also be tuned by adjusting the viscosity of the payload 120, as a more viscous payload 120 may wick slower than a less viscous payload 120.

In some examples, the progressive indicator 500 includes a laminated top layer including windows corresponding to each indicator region 514, such that the wick 510 is generally obscured to a viewer, and only the indicator regions 514 are viewable.

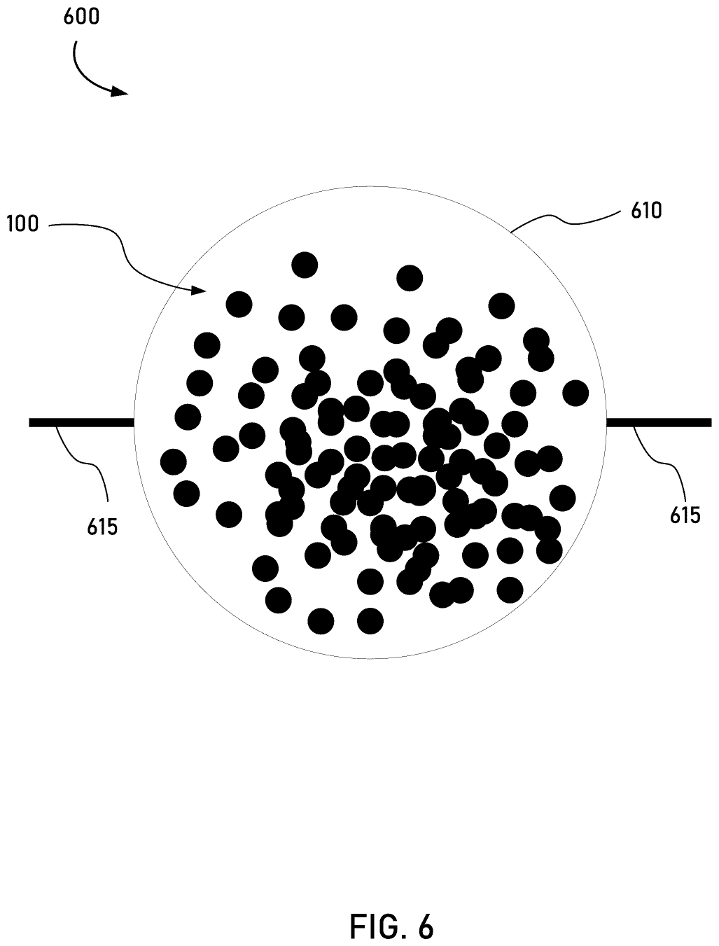

FIG. 6 illustrates an electrically sensitive indicator 600, according to embodiments of the present disclosure. The electrically sensitive indicator 600 includes a sensing region 610 in which a plurality of microcapsules 100 is disposed, and includes two electrodes 615 (e.g., wires) contacting opposite sides of the sensing region 610. The microcapsules 100 of the electrically sensitive indicator 600 can include electrically conductive particles or electrically non-conductive particles in the payload 120, such that following activation and the exposure to the predetermined environmental exposure, the conductive or non-conductive particles migrate through the liquefied payload 120 and form an electrical connection, disrupt an electrical connection, or change a dielectric between the electrodes 615.

In some examples, the electrically sensitive indicator 600 is connected to a circuit or chip via the electrodes 615 which is configured to measure an electrical property across the electrodes 615, where the electrical property is changed responsive to the formation of the electrical connection between the electrodes 615. Thus, by measuring the electrical property between the two electrodes, the state of the liquefiable material can be determined, or rather, an exposure of the liquefiable material to the predetermined environmental exposure may be confirmed.

According to some embodiments, the conductive particles may include particles of conductive metals, such as copper, silver, gold, aluminum, zinc, tin, similar metals, and alloys thereof. The conductive particles may also include particles of graphene, graphite, carbon black, graphene oxides, and other functionalized graphenes, and particles containing conductive non-metals. The conductive particles may be formed in whole or in part by any electrically conductive substance or material operable to be partialized to a sufficient size to fit within the shell of a microcapsule.

According to some embodiments, the conductive particles may be configured to change a conductivity, resistivity, impedance, or capacitance between the electrodes 615.

In the foregoing specification, specific embodiments have been described. However, one of ordinary skill in the art appreciates that various modifications and changes can be made without departing from the scope of the technology as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental exposure indicator comprising a plurality of microcapsules, each of the plurality of microcapsules further comprising:
a frangible shell;
a volatile material contained in the frangible shell, configured to transition to a gas when heated above a predetermined activation temperature;
wherein the frangible shell is configured to rupture responsive to a first activation action, the first activation action including an application of heat configured causing the volatile material to transition to a gas and expand in volume causing the frangible shell to weaken or rupture; and
a payload contained in the frangible shell, the payload containing a liquefiable material configured to liquefy responsive to a predetermined environmental exposure, the payload configured to be released from the frangible shell when the frangible shell is ruptured,
wherein, prior to the first activation action, the frangible shell is configured to contain the payload both when the liquefiable material is liquefied and when the liquefiable material is not liquefied.

2. The activatable environmental exposure indicator of claim 1, wherein the frangible shell is configured to rupture responsive to the volatile material expanding in volume by at least a predetermined amount.

3. The activatable environmental exposure indicator of claim 2, wherein the volatile material is contained in an expandable microsphere encapsulated within the frangible shell.

4. The activatable environmental exposure indicator of claim 1, wherein the frangible shells are configured to weaken responsive to the volatile material expanding in volume by at least a predetermined amount and configured to be ruptured responsive to a second activation action once weakened, the second activation action including an application of a compressive stress or a shear stress above a predetermined stress threshold.

5. The activatable environmental exposure indicator of claim 3, wherein the first activation action is an exposure to a temperature above the predetermined activation temperature for at least an activation threshold duration.

6. The activatable environmental exposure indicator of claim 5, wherein the predetermined environmental exposure is an exposure to a temperature above an indication threshold temperature for at least an indication threshold duration.

7. The activatable environmental exposure indicator of claim 6, wherein the indication threshold temperature is less than the predetermined activation temperature, and the indication threshold duration is greater than the activation threshold duration.

8. The activatable environmental exposure indicator of claim 5, wherein the predetermined activation temperature is in a range bounded by 50 degrees Celsius (C) and 350 degrees C.

9. The activatable environmental exposure indicator of claim 5, wherein the activation threshold duration is in a range bounded by 1 millisecond and 5 seconds.

10. (canceled)

11. The activatable environmental exposure indicator of claim 3, wherein the frangible shell comprises a polyurea formaldehyde, or a polymelamine formaldehyde.

12. The activatable environmental exposure indicator of claim 3, wherein the predetermined environmental exposure is selected from a group consisting of: a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

13. The activatable environmental exposure indicator of claim 3, wherein the liquefiable material is selected from a group consisting of a polymer having side-chain crystallinity, polymeric materials, an alkane, a wax, an alkane wax, esters, and combinations thereof.

14. The activatable environmental exposure indicator of claim 3, wherein the first activation action is a heat exposure applied by a thermal printhead.

15. The activatable environmental exposure indicator of claim 4, wherein the second activation action is a compressive stress applied by a thermal printhead.

16. The activatable environmental exposure indicator of claim 4, wherein the predetermined stress threshold is selected from a group consisting of: a stress exceeding 0.1 psi a stress exceeding 0.5 psi, a stress exceeding 1 psi, a stress exceeding 2 psi, a stress exceeding 5 psi, a stress exceeding 10 psi, and a stress exceeding 15 psi.

17. The activatable environmental exposure indicator of claim 3, wherein the payload further includes an indicator material, configured to produce an observable change in the activatable environmental exposure indicator after the liquefiable material is liquefied, the observable change selected from a group consisting of a change of reflectivity, a change in transparency, a change in hue, a change in chroma, a change in apparent color, a change in conductivity, a change in resistance, a change in impedance, a change in capacitance, and combinations thereof.

18. The activatable environmental exposure indicator of claim 3, wherein the payload further includes an indicator material selected from a group consisting of dyes, leuco dyes, a color forming agent, a color developing agent, chemical pigments, particles containing copper, particles containing silver, particles containing graphite, particles containing conductive metals, particles containing conductive non-metal materials, and combinations thereof.

19. The activatable environmental exposure indicator of claim 17, wherein the observable change is irreversible.

20. The activatable environmental exposure indicator of claim 3, wherein the volatile material contained in each microcapsule has a volume that is between 1% and 20% of a volume of each microcapsule before the volatile material expands.

21. The activatable environmental exposure indicator of claim 3, wherein the volatile material expands by between 10% and 1000% in response to the first activation action.

22. An activatable environmental exposure indicator, comprising:
a substrate;
a wick;
an indicator region;
a plurality of microcapsules, each microcapsule further comprising:
a frangible shell;
a volatile material contained in the frangible shell, configured to transition to a gas responsive to being heated above a predetermined activation temperature;
wherein the frangible shell is configured to rupture responsive to a first activation action, the first activation action including an application of heat configured causing the volatile material to transition to a gas and expand in volume causing the frangible shell to weaken or rupture; and
a payload contained in the frangible shell, the payload containing a liquefiable material configured to liquefy when exposed to a temperature above a predetermined indication temperature,
wherein the payload is configured to be released from the frangible shell when the frangible shell is ruptured,
wherein, prior to the first activation action, the frangible shell is configured to contain the payload when the liquefiable material is liquefied and when the liquefiable material is not liquefied; and
wherein after the payload is released from the frangible shell responsive to the first activation action, and responsive to the liquefiable material is liquefied, the payload is configured to migrate along the wick,
wherein the liquefiable material is configured to solidify when exposed to a temperature below the predetermined indication temperature, when the liquefiable material solidifies, the payload halts migration along the wick, and when the exposure to the temperature above the predetermined indication temperature resumes, the liquefiable material liquefies, and the payload resumes migration along the wick, and
wherein the payload is configured to reach the indicator region responsive to the liquefiable material having been liquefied for a predetermined cumulative period of time,
wherein the payload is configured to produce an observable effect in the indicator region when the payload reaches the indicator region.

23. The activatable environmental exposure indicator of claim 22, wherein the frangible shell is configured to rupture responsive to the volatile material expanding in volume.

24. The activatable environmental exposure indicator of claim 23, wherein the volatile material is contained in a microsphere encapsulated within the frangible shell.

25. (canceled)

26. (canceled)

27. The activatable environmental exposure indicator of claim 22, wherein the wick is configured such that the payload migrates along the wick at a predetermined rate when the liquefiable material is liquified, and the payload reaches the indicator region after a predetermined period of time and produces the observable effect.

28. The activatable environmental exposure indicator of claim 22, wherein the payload includes an indicator material contained or embedded in a matrix of the liquefiable material when the liquefiable material is solidified, such that when the liquefiable material is liquefied, the indicator material is released from the matrix.

29. The activatable environmental exposure indicator of claim 28, wherein the liquefiable material, when liquefied, is configured to facilitate migration of the indicator material to the indicator region.

30. (canceled)

31. The activatable environmental exposure indicator of claim 28, wherein the payload comprises a first substance which is held in the matrix, and the indicator region includes a second substance reactive with the first substance, and the first substance and the second substance react with one another when the first substance is released from the matrix and migrates to the indicator region when the liquefiable material is liquefied, such that a reaction between the first substance and the second substance produces the observable effect.

32. The activatable environmental exposure indicator of claim 28, wherein the liquefiable material is selected from a group consisting of a polymer having side-chain crystallinity, polymeric materials, an alkane, a wax, an alkane wax, esters, and combinations thereof.

33. The activatable environmental exposure indicator of claim 28, wherein the indicator material is selected from a group consisting of a colorant, a color forming agent, a color developing agent, a dye, a leuco dyes, a chemical pigment, particles containing copper, particles containing silver, particles containing graphite, particles containing conductive metals, particles containing conductive non-metal materials, and combinations thereof.

34. The activatable environmental exposure indicator of claim 30, wherein the observable effect is a change in an apparent color state of the indicator region selected from a group consisting of a change of reflectivity, a change in transparency, a change in hue, a change in chroma, a change in apparent color, and combinations thereof.

35. The activatable environmental exposure indicator of claim 22, wherein the observable effect is a change in an electrical property of the indicator region selected from a group consisting of a change in conductivity, a change in resistance, a change in impedance, a change in capacitance, and combinations thereof.

36. The activatable environmental exposure indicator of claim 22, wherein the first activation action is an exposure to a temperature above the predetermined activation temperature for at least an activation threshold duration.

37. (canceled)

38. The activatable environmental exposure indicator of claim 36, wherein the predetermined activation temperature is defined within a range bounded by 50 degrees Celsius (C) and 350 degrees C.

39. (canceled)

40. The activatable environmental exposure indicator of claim 22, wherein the predetermined indication temperature is defined within a range bounded by −15 degrees Celsius (C) and 35 degrees C.

41. (canceled)

42. (canceled)

43. (canceled)

44. The activatable environmental exposure indicator of claim 22, wherein the frangible shell comprises a polyurea formaldehyde, or a polymelamine formaldehyde.

45. (canceled)
